(19) United States
(12) Patent Application Publication
(10) Pub. No.: US 2010/0097991 A1
(43) Pub. Date: Apr. 22, 2010

(54) COMMUNICATION METHOD, COMMUNICATION SYSTEM, MOBILE COMMUNICATION DEVICE, AND DESTINATION PARTNER COMMUNICATION DEVICE

(75) Inventor: Tetsuro Morimoto, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/523,234

(22) PCT Filed: Jan. 17, 2008
(86) PCT No.: PCT/JP2008/050485

§ 371 Date: Jul. 15, 2009

(30) Foreign Application Priority Data
Jan. 19, 2007 (JP) 2007-010773

(51) Int. Cl. H04W 40/00

(52) U.S. Cl. 370/328

(57) ABSTRACT

A technology is disclosed for performing route optimization on only a one-way direct route when communication is performed between a mobile node and a correspondent node on a direct route without passing through a home agent of the mobile node. In the technology, (1) the MN transmits a HoTi message to the CN via the HA, (2) the CN transmits a HoT message to the MN via the HA in response to the HoTi message, (3) the MN transmits a CoTiα message directly to the CN, (4) the CN authenticates the CoTiα message and transmits a CoTiα message to the MN via the HA, (5) the MN transmits a BUα message directly to the CN, and (6) the CN authenticates the BUα message and transmits a BAα message to the MN via the HA.

### TECHNICAL FIELD

The present invention relates to a communication method, a communication system, a mobile communication device, and a destination partner communication device for performing route optimization (RO) in which communication between the mobile communication device and the destination partner communication device is performed using a direct route, without using a home agent of the mobile communication device.

### BACKGROUND ART

Conventionally, mobile IP is known as a technology allowing a communication device to continue using the same IP address as that before movement, even when the communication device moves. In mobile IP, a home agent (HA) receives a packet addressed to a home address (HoA) of a mobile communication device (mobile node [MN]) and transfers the packet to a care-of address (CoA) of the mobile node. Therefore, regardless of a change in address accompanying movement, the mobile node can continue communication using the home address. Route optimization (RO) technology is known for improving a roundabout communication route between the mobile node and a destination partner communication device (correspondent node [CN]) caused by the packet being sent by way of the home agent. In route optimization, the communication route between the mobile node and the correspondent node is directly connected. In route optimization, communication is performed using the CoA by the correspondent node storing correspondence between the HoA and the CoA of the mobile node. A process for storing the correspondence between the HoA and the CoA of the mobile node in the correspondent node is referred to as a binding update (BU).

Unlike a binding update performed on the home agent, the binding update performed on the correspondent node requires a return routability procedure to be performed. Because security association can be established in advance between the home agent and the mobile node, the return routability procedure is not required. In the binding update performed on the home agent, when the mobile node notifies the home agent of a new care-of address for the home address, the home agent can confirm that the notification is a binding update request from the mobile node through the security association (IPsec SA and the like) established in advance.

On the other hand, in the binding update performed on the correspondent node, it is difficult to establish security association between the mobile node and correspondent nodes in advance, before the binding update is performed, for all communication devices that are potential communication partners. If a correspondent node complies with a request for a binding update when the security association is not established, an attack in which an attacker impersonates the mobile node occurs more easily. When the attacker performs the binding update on the correspondent node, a packet addressed to the mobile node may be transferred to an unauthorized care-of address. The return routability procedure is a technology for preventing this attack. Specifically, in the return routability procedure, a home test and a care-of test are performed. Unauthorized binding updates are prevented by results of these tests being reflected in the binding update. Conventional technologies, such as the above-described mobile IP, route optimization, and return routability procedure, are described in Non-patent Document 1, below. A design concept of the return routability procedure is described in Non-Patent Document 2, below.

The return routability procedure will be described in detail. In the home test, the mobile node transmits a home test init (HoTi) message to the correspondent node. The correspondent node returns a home test (HoT) message. In the care-of test, the mobile node transmits a care-of test init (CoTi) message to the correspondent node. The correspondent node returns a care-of test (CoT) message. The mobile node generates a key based on a home keygen token and a care-of keygen token respectively included in the HoT message and the CoT message returned as in response by the correspondent node. The mobile node calculates a message authentication code (MAC) of a binding update (BU) message using the generated key. The mobile node adds the MAC to the BU message and transmits the BU message.

The correspondent node that receives the BU message checks the message authentication code within the BU message, thereby judging that the BU message is an authentic BU message transmitted from the mobile node. According to the Non-patent Document 2 describing the design concept of the return routability procedure, the return routability procedure is designed such that the correspondent node is not required to hold a state. In other words, the BU message can be authenticated without the correspondent node having to store information regarding whether the HoTi message has been received and whether the CoTi message has been received. As a result, damage to the correspondent node can be reduced if an attacker launches a denial of service (DoS) attack on the correspondent node using the HoTi message and the CoTi message. A single response message is returned for a single request message, such as “a HoT message is returned for a HoTi message” and “a CoT message is returned for a CoTi message”, to prevent amplification of messages. This is because, when a plurality of response messages are returned for a single request message, an attacker can attack a plurality of targets by sending a single message. Moreover, the response message is returned to a source of the request message, such as “a HoT message being returned to a source of a HoTi message” and “a CoT message being returned to a source of a CoTi message”, to avoid reflection of the messages. Reflection of the messages refers to process in which the response message is transmitted to an address other than that of the source of the request message. Reflection becomes a problem when used by an attacker. For example, when the HoT message is transmitted to a care-of address (in actuality, the HoT message is transmitted to the HoA that is the source address of the HoTi message to prevent reflection), the attacker attacks a target (care-of address) by transmitting the HoTi message from the HoA to a certain terminal that performs reflection. The HOT message is transmitted to the target from the terminal performing reflection. At this time, a terminal that has become the target is attacked by an unnecessary HoT message, but cannot know who the attacker is because the source address is that of the terminal performing the reflection.
Non-patent Document 1: RFC 3775 “Mobility Support in IPv6”
Non-patent Document 2: RFC 4225 “Mobile IP Version 6 Route Optimization Security Design Background”

However, a problem is present in that route optimization of the convention technology cannot be used in a one-way network. Specifically, bi-directional reachability is required to perform route optimization. Therefore, the binding update cannot be performed on a route over which data flows in only one direction, such as satellite communication and digital television broadcasts.

For example, when communication can only be performed in a direction from the MN to the CN, the BU message transmitted from the MN to the CN reaches the CN. However, a binding acknowledgement (BA) message transmitted from the CN to the MN does not reach the MN. Therefore, the MN cannot perform the binding update on the CN. Moreover, the CoTi message transmitted from the MN to the CN reaches the CN. However, the CoT message transmitted from the CN to the MN does not reach the MN. Therefore, the return routability procedure cannot be performed. On the other hand, when communication can only be performed in a direction from the CN to the MN, the BU message transmitted from the MN to the CN does not reach the CN. Therefore, the binding update cannot be performed. Moreover, the CoTi message transmitted from the MN to the CN does not reach the CN. Therefore, the return routability procedure cannot be performed.

In this way, the return routability procedure and the binding update cannot be performed on a route in which communication can only be performed in one direction. Therefore, a problem is present in that route optimization cannot be performed using a one-way route on which communication can be performed. Therefore, when a large volume of data is transferred through effective use of a one-way route, such as a route in which only a downlink route can be used, like satellite communication and digital television broadcasts, route optimization cannot be performed because the return routability procedure and the binding update cannot be performed on the one-way route. This is a significant problem.

Issues arising when a route over which a packet travels in only one direction is present on a route on which route optimization is to be performed are described above. However, similar issues to those occurring when one-way route optimization cannot be used also arise in an asymmetrical network. Here, the asymmetrical network refers to a network in which, although packets can be transmitted and received bi-directionally, bandwidth is wide in only one direction and narrow in the other direction. In an asymmetrical network such as this, the request messages and the response messages for the return routability procedure and the binding update can be transmitted and received. Therefore, the conventional binding update can be performed, and route optimization can be used. However, because the network is asymmetrical, it may not be preferable for the MN to use an optimized route in both directions. In other words, the conventional technology cannot support demands to use an optimized route for only packets transmitted to the CN or, alternatively, for only packets received from the CN.

### DISCLOSURE OF THE INVENTION

The present invention has been achieved in light of the above-described issues. An object of the present invention is to provide a communication method, a communication system, a mobile communication device, and a destination partner communication device that can perform a return routability procedure and a binding update to allow actualization of route optimization, while maintaining security on a one-way route and an asymmetrical route to a degree similar to that achieved by conventional technology.

To achieve the above-described object, a communication method of the present invention is a communication method for performing route optimization for performing communication between a mobile node and a correspondent node by a direct route, without passing through a home agent of the mobile node. The communication method includes a one-way route optimization step at which communication is performed on a one-way direct route in only a direction from the mobile node to the correspondent node. The one-way route optimization step includes a home address test step at which the mobile node transmits a first request message to the correspondent node via the home agent. The correspondent node responds to the first request message and transmits a first response message including message authentication code generation information to the mobile node via the home agent. The one-way route optimization step also includes a care-of address test step at which the mobile node generates a first message authentication code from the message authentication code generation information within the first response message and transmits a second request message including the first message authentication code to the correspondent node via the one-way direct route. The correspondent node authenticates the first message authentication code and transmits a second response message including a care-of address of the mobile node to the mobile node via the home agent. The one-way route optimization step also includes a binding update authentication step at which the mobile node generates a second message authentication code from the care-of address of the mobile node within the second response message and transmits a binding update message including the second message authentication code to the correspondent node via the one-way direct route. The correspondent node authenticates the second message authentication code and transmits a binding confirmation message to the mobile node via the home agent.

As a result of the above-described method, route optimization can be actualized when communication is performed on a one-way direct route in only a direction from the mobile node to the correspondent node.

To achieve the above-described object, a communication system of the present invention is a communication system for performing route optimization for performing communication between a mobile node and a correspondent node by a direct route, without passing through a home agent of the mobile node. The communication system includes a one-way route optimization means for performing communication on a one-way direct route in only a direction from the mobile node to the correspondent node. The one-way route optimization means includes a home address test means by which the mobile node transmits a first request message to the correspondent node via the home agent. The correspondent node responds to the first request message and transmits a first response message including message authentication code generation information to the mobile node via the home agent. The one-way route optimization means also includes a care-of address test means by which the mobile node generates a first message authentication code from the message authentication code generation information within the first response message and transmits a second request message including the first message authentication code to the correspondent node via the one-way direct route. The correspondent node authenticates the first message authentication code and transmits a second response message including a care-of address of the mobile node to the mobile node via the home agent. The one-way route optimization means also includes a binding update authentication means by which the mobile node generates a second message authentication code from the care-of address of the mobile node within the second response message and transmits a binding update message including the second message authentication code to the correspondent node via the one-way direct route. The correspondent node authenticates the second message authentication code and transmits a binding confirmation message to the mobile node via the home agent.

As a result of the above-described configuration, route optimization can be actualized when communication is performed on a one-way direct route in only a direction from the mobile node to the correspondent node.

To achieve the above-described object, a mobile node of the present invention is a mobile node in a communication system for performing route optimization for performing communication between the mobile node and a correspondent node by a direct route, without passing through a home agent of the mobile node. The mobile node includes a means for transmitting a first request message to the correspondent node via the home agent when communication is performed on a one-way direct route in only a direction from the mobile node to the correspondent node. The mobile node also includes a means for receiving a first response message when the correspondent node responds to the first request message and transmits the first response message including message authentication code generation information via the home agent. The mobile node also includes a means for generating a first message authentication code from the message authentication code generation information within the received first response message and transmitting a second request message including the first message authentication code to the correspondent node via the one-way direct route. The mobile node also includes a means for receiving a second response message when the correspondent node authenticates the first message authentication code and transmits the second response message including a care-of address of the mobile node via the home agent. The mobile node also includes a means for generating a second message authentication code from the care-of address of the mobile node within the received second response message and transmitting a binding update message including the second message authentication code via the one-way direct route. The mobile node also includes a means for receiving a binding confirmation message when the correspondent node authenticates the second message authentication code and transmits the binding confirmation message via the home agent.

As a result of the above-described configuration, route optimization can be actualized when communication is performed on a one-way direct route in only a direction from the mobile node to the correspondent node.

To achieve the above-described object, a correspondent node of the present invention is a correspondent node in a communication system for performing route optimization for performing communication between a mobile node and the correspondent node by a direct route, without passing through a home agent of the mobile node. The correspondent node includes a means for receiving a first request message when the mobile node transmits the first request message via the home agent when communication is performed on a one-way direct route in only a direction from the mobile node to the correspondent node. The correspondent node also includes a means for transmitting a first response message including message authentication code generation information to the mobile node via the home agent in response to the first request message. The correspondent node also includes a means for receiving a second request message when the mobile node generates a first message authentication code from the message authentication code generation information within the first response message and transmits the second request message including the first message authentication code via the one-way direct route. The correspondent node also includes a means for authenticating the first message authentication code within the second request message and transmitting a second response message including a care-of address of the mobile node to the mobile node via the home agent. The correspondent node also includes a means for receiving a binding update message when the mobile node generates a second message authentication code from the care-of address of the mobile node within the second response message and transmits the binding update message including the second message authentication code via the one-way direct route. The correspondent node also includes a means for authenticating the second message authentication code within the binding update message and transmitting a binding confirmation message to the mobile node via the home agent.

As a result of the above-described configuration, route optimization can be actualized when communication is performed on a one-way direct route in only a direction from the mobile node to the correspondent node.

The correspondent node of the present invention further includes a means for setting a flag in a binding cache entry when communication is performed on a one-way direct route in only a direction from the mobile node to the correspondent node. The flag indicates that communication is performed on the one-way direct route in only the direction from the mobile node to the correspondent node. The correspondent node also includes a means for transmitting a transmission packet addressed to the mobile node when the flag is set. A destination address of the packet is the home address. The destination address is not changed from the home address to the care-of address.

As a result of the above-described configuration, route optimization can be actualized when communication is performed on a one-way direct route in only a direction from the mobile node to the correspondent node.

To achieve the above-described object, a communication method of the present invention is a communication method for performing route optimization for performing communication between a mobile node and a correspondent node by a direct route, without passing through a home agent of the mobile node. The communication method includes a one-way route optimization step at which communication is performed on a one-way direct route in only a direction from the correspondent node to the mobile node. The one-way route optimization step includes a home address test step at which the mobile node transmits a first request message to the correspondent node via the home agent. The correspondent node responds to the first request message and transmits a first response message including message authentication code generation information to the mobile node via the home agent. The one-way route optimization step also includes a care-of address test step at which the mobile node generates a first message authentication code from the message authentication code generation information within the first response message and transmits a second request message including the first message authentication code to the correspondent node via the home agent. The correspondent node authenticates the first message authentication code and transmits a second response message including a home address of the mobile node to the mobile node via the one-way direct route. The one-way route optimization step also includes a binding update authentication step at which the mobile node generates a second message authentication code from the home address of the mobile node within the second response message and transmits a binding update message including the second message authentication code to the correspondent node via the home agent. The correspondent node authenticates the second message authentication code and transmits a binding confirmation message to the mobile node via the one-way direct route.

As a result of the above-described method, route optimization can be actualized when communication is performed on a one-way direct route in only a direction from the correspondent node to the mobile node.

To achieve the above-described object, a communication system of the present invention is a communication system for performing route optimization for performing communication between a mobile node and a correspondent node by a direct route, without passing through a home agent of the mobile node. The communication system includes a one-way route optimization means for performing communication on a one-way direct route in only a direction from the correspondent node to the mobile node. The one-way route optimization means includes a home address test means by which the mobile node transmits a first request message to the correspondent node via the home agent. The correspondent node responds to the first request message and transmits a first response message including message authentication code generation information to the mobile node via the home agent. The one-way route optimization means includes a care-of address test means by which the mobile node generates a first message authentication code from the message authentication code generation information within the first response message and transmits a second request message including the first message authentication code to the correspondent node via the home agent. The correspondent node authenticates the first message authentication code and transmits a second response message including a home address of the mobile node to the mobile node via the one-way direct route. The one-way route optimization means also includes a binding update authentication means by which the mobile node generates a second message authentication code from the home address of the mobile node within the second response message and transmits a binding update message including the second message authentication code to the correspondent node via the home agent. The correspondent node authenticates the second message authentication code and transmits a binding confirmation message to the mobile node via the one-way direct route.

As a result of the above-described configuration, route optimization can be actualized when communication is performed on a one-way direct route in only a direction from the correspondent node to the mobile node.

To achieve the above-described object, a mobile node of the present invention is a mobile node in a communication system for performing route optimization for performing communication between the mobile node and a correspondent node by a direct route, without passing through a home agent of the mobile node. The mobile node includes a means for transmitting a first request message to the correspondent node via the home agent when communication is performed on a one-way direct route in only a direction from the correspondent node to the mobile node. The mobile node also includes a means for receiving a first response message when the correspondent node responds to the first request message and transmits the first response message including message authentication code generation information via the home agent. The mobile node also includes a means for generating a first message authentication code from the message authentication code generation information within the received first response message and transmitting a second request message including the first message authentication code to the correspondent node via the home agent. The mobile node also includes a means for receiving a second response message when the correspondent node authenticates the first message authentication code and transmits the second response message including a home address of the mobile node via the one-way direct route. The mobile node also includes a means for generating a second message authentication code from the home address of the mobile node within the received second response message and transmitting a binding update message including the second message authentication code via the home agent. The mobile node also includes a means for receiving a binding confirmation message when the correspondent node authenticates the second message authentication code and transmits the binding confirmation message via the one-way direct route.

As a result of the above-described configuration, route optimization can be actualized when communication is performed on a one-way direct route in only a direction from the correspondent node to the mobile node.

The mobile node of the present invention further includes a means for setting a flag in a binding cache entry when communication is performed on a one-way direct route in only a direction from the correspondent node to the mobile node. The flag indicates that communication is performed on the one-way direct route in only the direction from the correspondent node to the mobile node. The mobile node further includes a means for transmitting a transmission packet addressed to the correspondent node when the flag is set. A destination address of the packet is the home address. The destination address is not changed from the home address to the care-of address.

As a result of the above-described configuration, route optimization can be actualized when communication is performed on a one-way direct route in only a direction from the correspondent node to the mobile node.

To achieve the above-described object, a correspondent node of the present invention is a correspondent node in a communication system for performing route optimization for performing communication between a mobile node and the correspondent node by a direct route, without passing through a home agent of the mobile node. The correspondent node includes a means for receiving a first request message when the mobile node transmits the first request message via the home agent when communication is performed on a one-way direct route in only a direction from the correspondent node to the mobile node. The correspondent node also includes a means for transmitting a first response message including message authentication code generation information to the mobile node via the home agent in response to the received first request message. The correspondent node also includes a means for receiving a second request message when the mobile node generates a first message authentication code from the message authentication code generation information within the first response message and transmits the second request message including the first message authentication code via the home agent. The correspondent node also includes a means for authenticating the first message authentication code within the received second request message and transmitting a second response message including a home address of the mobile node to the mobile node via the one-way direct route. The correspondent node also includes a means for receiving a binding update message when the mobile node generates a second message authentication code from the home address of the mobile node within the second response message and transmits the binding update message including the second message authentication code via the home agent. The correspondent node also includes a means for authenticating the second message authentication code within the binding update message and transmitting a binding confirmation message to the mobile node via the one-way direct route.

As a result of the above-described configuration, route optimization can be actualized when communication is performed on a one-way direct route in only a direction from the correspondent node to the mobile node.

The mobile node of the present invention transmits a request message that does not include the first message authentication code to the correspondent node via the one-way direct route before transmitting the second request message, and transmits the second request message when a response message is not returned from the correspondent node via the one-way direct route.

As a result of the above-described configuration, when an attempt to perform route optimization of a two-way direct route fails, route optimization of a one-way direct route in only a direction from the correspondent node to the mobile node and a one-way direct route in only a direction from the mobile node to the correspondent node can be actualized.

In the mobile communication method of the present invention, when communication is performed on a one-way direct route in only a direction from the mobile node to the correspondent node refers to when the mobile node has a plurality of interfaces, a plurality of correspondent nodes are present, and the mobile node transmits a transmission packet to each of the plurality of correspondent nodes from each of the plurality of interfaces.

As a result of the above-described method, route optimization can be actualized when a direct route between the mobile node and the correspondent node is asymmetrical.

In the mobile communication method of the present invention, when communication is performed on a one-way direct route in only a direction from the correspondent node to the mobile node refers to when the mobile node has a plurality of interfaces, a plurality of correspondent nodes are present, and the mobile node transmits a transmission packet from each of the plurality of correspondent nodes to each of the plurality of interfaces.

As a result of the above-described method, route optimization can be actualized when a direct route between the mobile node and the correspondent node is asymmetrical.

In the present invention, the return routability procedure and the binding update can be performed to allow actualization of route optimization, while maintaining security on a one-way route and an asymmetrical route to a degree similar to that achieved by conventional technology.

### BRIEF DESCRIPTION OF THE DRAWINGS

FIG. 1A is an explanatory diagram of an overview of a communication method performing communication between a mobile node and a correspondent node on a one-way direct route without passing through a home agent of the mobile node, according to an embodiment of the present invention, and is a diagram of when communication is performed on a one-way direct route in only a direction from the mobile node to the correspondent node;

FIG. 1B is an explanatory diagram of an overview of a communication method performing communication between a mobile node and a correspondent node on a one-way direct route without passing through a home agent of the mobile node, according to an embodiment of the present invention, and is a diagram of when communication is performed on a one-way direct route in only a direction from the correspondent node to the mobile node;

FIG. 2A is an explanatory diagram of routes of a binding update message and a binding confirmation message according to the embodiment of the present invention, and is a diagram of when communication is performed on a one-way direct route in only a direction from the mobile node to the correspondent node;

FIG. 2B is an explanatory diagram of routes of a binding update message and a binding confirmation message according to the embodiment of the present invention, and is a diagram of when communication is performed on a one-way direct route in only a direction from the correspondent node to the mobile node;

FIG. 3A is an explanatory diagram of routes of a CoTi message and CoT message according to the embodiment of the present invention, and is a diagram of when communication is performed on a one-way direct route in only a direction from the mobile node to the correspondent node;

FIG. 3B is an explanatory diagram of routes of a CoTi message and CoT message according to the embodiment of the present invention, and is a diagram of when communication is performed on a one-way direct route in only a direction from the correspondent node to the mobile node;

FIG. 4A is an explanatory diagram of a conventional return routability procedure, and is a diagram of a route of a HoTi message;

FIG. 4B is an explanatory diagram of the conventional return routability procedure, and is a diagram of a route of a HoT message;

FIG. 4C is an explanatory diagram of the conventional return routability procedure, and is a diagram of contents of the HoTi/HoT messages;

FIG. 4D is an explanatory diagram of a conventional return routability procedure, and is a diagram of a route of a CoTi message;

FIG. 4E is an explanatory diagram of the conventional return routability procedure, and is a diagram of a route of a CoT message;

FIG. 4F is an explanatory diagram of the conventional return routability procedure, and is a diagram of contents of the CoTi/CoT messages;

FIG. 4G is an explanatory diagram of a conventional return routability procedure, and is a diagram of a route of a BU message;

FIG. 4H is an explanatory diagram of the conventional return routability procedure, and is a diagram of a route of a BA message;

FIG. 4I is an explanatory diagram of the conventional return routability procedure, and is a diagram of contents of the BU/BA messages;

FIG. 5A is an explanatory diagram of an overview of a communication method when communication is performed on a one-way direct route in only a direction from the mobile node to the correspondent node according to the embodiment of the present invention, and is a diagram of a route of a HoTi message;

FIG. 5B is an explanatory diagram of an overview of the communication method when communication is performed on a one-way direct route in only a direction from the mobile node to the correspondent node according to the embodiment of the present invention, and is a diagram of a route of a HoT message;

FIG. 5C is an explanatory diagram of an overview of the communication method when communication is performed on a one-way direct route in only a direction from the mobile node to the correspondent node according to the embodiment of the present invention, and is a diagram of a route of a CoTi message;

FIG. 5D is an explanatory diagram of an overview of the communication method when communication is performed on a one-way direct route in only a direction from the mobile node to the correspondent node according to the embodiment of the present invention, and is a diagram of a route of a CoT message;

FIG. 5E is an explanatory diagram of an overview of the communication method when communication is performed on a one-way direct route in only a direction from the mobile node to the correspondent node according to the embodiment of the present invention, and is a diagram of a route of a CoTiα message;

FIG. 5F is an explanatory diagram of an overview of the communication method when communication is performed on a one-way direct route in only a direction from the mobile node to the correspondent node according to the embodiment of the present invention, and is a diagram of a route of a CoTα message;

FIG. 5G is an explanatory diagram of an overview of the communication method when communication is performed on a one-way direct route in only a direction from the mobile node to the correspondent node according to the embodiment of the present invention, and is a diagram of a route of a BUα message;

FIG. 5H is an explanatory diagram of an overview of the communication method when communication is performed on a one-way direct route in only a direction from the mobile node to the correspondent node according to the embodiment of the present invention, and is a diagram of a route of a BAα message;

FIG. 6 is an explanatory diagram of a message format storing a message type according to the embodiment of the present invention;

FIG. 7A is an explanatory diagram of a return routability procedure when communication is performed on a one-way direct route in only a direction from the mobile node to the correspondent node according to the embodiment of the present invention, and is a diagram of a route of a HoTi message;

FIG. 7B is an explanatory diagram of the return routability procedure when communication is performed on a one-way direct route in only a direction from the mobile node to the correspondent node according to the embodiment of the present invention, and is a diagram of a route of a HoT message;

FIG. 7C is an explanatory diagram of the return routability procedure when communication is performed on a one-way direct route in only a direction from the mobile node to the correspondent node according to the embodiment of the present invention, and is a diagram of contents of the HoTi/HoT messages;

FIG. 7D is an explanatory diagram of a return routability procedure when communication is performed on a one-way direct route in only a direction from the mobile node to the correspondent node according to the embodiment of the present invention, and is a diagram of a route of a CoTiα message;

FIG. 7E is an explanatory diagram of the return routability procedure when communication is performed on a one-way direct route in only a direction from the mobile node to the correspondent node according to the embodiment of the present invention, and is a diagram of a route of a CoTα message;

FIG. 7F is an explanatory diagram of the return routability procedure when communication is performed on a one-way direct route in only a direction from the mobile node to the correspondent node according to the embodiment of the present invention, and is a diagram of contents of the CoTiα/CoTα messages;

FIG. 7G is an explanatory diagram of a return routability procedure when communication is performed on a one-way direct route in only a direction from the mobile node to the correspondent node according to the embodiment of the present invention, and is a diagram of a route of a BUα message;

FIG. 7H is an explanatory diagram of the return routability procedure when communication is performed on a one-way direct route in only a direction from the mobile node to the correspondent node according to the embodiment of the present invention, and is a diagram of a route of a BAα message;

FIG. 7I is an explanatory diagram of the return routability procedure when communication is performed on a one-way direct route in only a direction from the mobile node to the correspondent node according to the embodiment of the present invention, and is a diagram of contents of the BUα/BAα messages;

FIG. 8 is an explanatory diagram of a binding cache entry of the correspondent node when communication is performed on a one-way direct route in only a direction from the mobile node to the correspondent node according to the embodiment of the present invention;

FIG. 9 is an explanatory diagram of a communication sequence when communication is performed on a one-way direct route in only a direction from the mobile node to the correspondent node according to the embodiment of the present invention;

FIG. 10A is a an explanatory diagram of an overview of a communication method when communication is performed on a one-way direct route in only a direction from the correspondent node to the mobile node according to the embodiment of the present invention, and is a diagram of a route of a HoTi message;

FIG. 10B is an explanatory diagram of an overview of the communication method when communication is performed on a one-way direct route in only a direction from the correspondent node to the mobile node according to the embodiment of the present invention, and is a diagram of a route of a HoT message;

FIG. 10C is an explanatory diagram of an overview of the communication method when communication is performed on a one-way direct route in only a direction from the correspondent node to the mobile node according to the embodiment of the present invention, and is a diagram of a route of a CoTi message;

FIG. 10D is an explanatory diagram of an overview of the communication method when communication is performed on a one-way direct route in only a direction from the correspondent node to the mobile node according to the embodiment of the present invention, and is a diagram of a route of a CoT message;

FIG. 10E is an explanatory diagram of an overview of the communication method when communication is performed on a one-way direct route in only a direction from the correspondent node to the mobile node according to the embodiment of the present invention, and is a diagram of a route of a CoTβ message;

FIG. 10F is an explanatory diagram of an overview of the communication method when communication is performed on a one-way direct route in only a direction from the correspondent node to the mobile node according to the embodiment of the present invention, and is a diagram of a route of a CoTβ message;

FIG. 10G is an explanatory diagram of an overview of the communication method when communication is performed on a one-way direct route in only a direction from the correspondent node to the mobile node according to the embodiment of the present invention, and is a diagram of a route of a BUβ message;

FIG. 10H is an explanatory diagram of an overview of the communication method when communication is performed on a one-way direct route in only a direction from the correspondent node to the mobile node according to the embodiment of the present invention, and is a diagram of a route of a BAβ message;

FIG. 11A is an explanatory diagram of a return routability procedure when communication is performed on a one-way direct route in only a direction from the correspondent node to the mobile node according to the embodiment of the present invention, and is a diagram of a route of a HoTi message;

FIG. 11B is an explanatory diagram of the return routability procedure when communication is performed on a one-way direct route in only a direction from the correspondent node to the mobile node according to the embodiment of the present invention, and is a diagram of a route of a HoT message;

FIG. 11C is an explanatory diagram of the return routability procedure when communication is performed on a one-way direct route in only a direction from the correspondent node to the mobile node according to the embodiment of the present invention, and is a diagram of contents of the HoTi/HoT messages;

FIG. 11D is an explanatory diagram of a return routability procedure when communication is performed on a one-way direct route in only a direction from the correspondent node to the mobile node according to the embodiment of the present invention, and is a diagram of a route of a CoTiβ message;

FIG. 11E is an explanatory diagram of the return routability procedure when communication is performed on a one-way direct route in only a direction from the correspondent node to the mobile node according to the embodiment of the present invention, and is a diagram of a route of a CoTβ message;

FIG. 11F is an explanatory diagram of the return routability procedure when communication is performed on a one-way direct route in only a direction from the correspondent node to the mobile node according to the embodiment of the present invention, and is a diagram of contents of the CoTiβ/CoTβ messages;

FIG. 11G is an explanatory diagram of a return routability procedure when communication is performed on a one-way direct route in only a direction from the correspondent node to the mobile node according to the embodiment of the present invention, and is a diagram of a route of a BUβ message;

FIG. 11H is an explanatory diagram of the return routability procedure when communication is performed on a one-way direct route in only a direction from the correspondent node to the mobile node according to the embodiment of the present invention, and is a diagram of a route of a BAβ message;

FIG. 11I is an explanatory diagram of the return routability procedure when communication is performed on a one-way direct route in only a direction from the correspondent node to the mobile node according to the embodiment of the present invention, and is a diagram of contents of the BUβ/BAβ messages;

FIG. 12 is an explanatory diagram of a binding cache entry of the correspondent node when communication is performed on a one-way direct route in only a direction from the correspondent node to the mobile node according to the embodiment of the present invention;

FIG. 13 is an explanatory diagram of a binding cache entry of the mobile node when communication is performed on a one-way direct route in only a direction from the correspondent node to the mobile node according to the embodiment of the present invention;

FIG. 14 is an explanatory diagram of a communication sequence when communication is performed on a one-way direct route in only a direction from the correspondent node to the mobile node according to the embodiment of the present invention;

FIG. 15 is an explanatory diagram of a message format storing home nonce ID according to the embodiment of the present invention;

FIG. 16 is an explanatory diagram of a message format storing a home address according to the embodiment of the present invention;

FIG. 17 is an explanatory diagram of a message format storing a care-of address according to the embodiment of the present invention;

FIG. 18 is an explanatory diagram of a message format storing a MAC (Kbm1) according to the embodiment of the present invention;

FIG. 19 is a block diagram of a message processing unit of the mobile node according to the embodiment of the present invention;

FIG. 20 is a block diagram of a message processing unit of the correspondent node according to the embodiment of the present invention;

FIG. 21A is an explanatory diagram of an asymmetrical route according to the embodiment of the present invention, and is a diagram of when a transmission packet is transmitted form each of a plurality of interfaces of the mobile node to each of a plurality of correspondent nodes; and

FIG. 21B is an explanatory diagram of an asymmetrical route according to the embodiment of the present invention, and is a diagram of when a transmission packet is transmitted from each of a plurality of correspondent nodes to each of a plurality of interfaces of the mobile node.

### BEST MODE FOR CARRYING OUT THE INVENTION

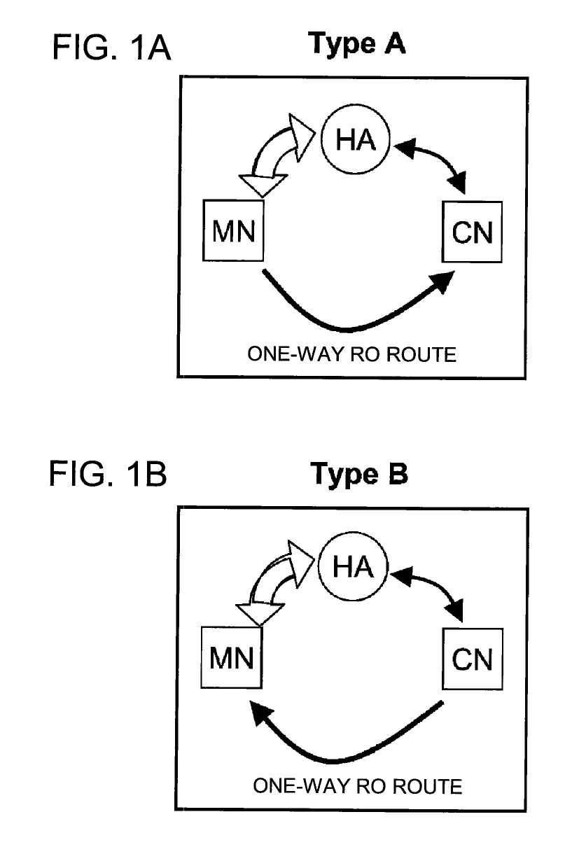

Embodiments of the present invention will hereinafter be described with reference to the drawings. Here, regarding a one-way route, operations differ depending on a direction in which a packet flows. Therefore, names are given to differentiate between the operations. Type A refers to when a route to be optimized is used in only one direction, from a MN to a CN, as shown in FIG. 1A. On the other hand, Type B refers to when the route is used in only a direction from the CN to the MN, as shown in FIG. 1B.

### Points of the Present Invention

(1) Modification to Binding Cache Entry (BCE)

A flag area is added to a BCE (one-way BCE) corresponding to one-way route optimization (one-way RO) to judge whether route optimization is performed. In Type A, the CN transmits a packet still addressed to a HoA without performing route optimization. Therefore, a flag (transmission RO inapplicability judgment flag) is set in the BCE to indicate that route optimization is not performed during transmission. From this alone, it appears that the CN does not require the BCE. However, the CN requires the BCE during a reception process of a packet. In other words, the CN requires the BCE when processing a home address option added to a received packet, to check consistency regarding whether a correspondence between a source address (CoA) and a HoA included in the home address option is correct.

In Type B, the MN transmits a packet of which the source address remains the HoA, without replacing the source address with the CoA and without performing a process to add the home address option. Therefore, a flag (transmission RO inapplicability judgment flag) is set in the BCE of the MN to indicate that route optimization is not applied during transmission, so that a RO process is not performed in this way. However, the BCE is not unnecessary in this instance, as well. The MN requires the BCE to check whether the CN is transmitting a packet after performing route optimization (whether a packet addressed to the CoA is transmitted with a routing header attached), to manage a lifetime of the BCE of the CN, and the like.

(2) Modification of Binding Update Procedure

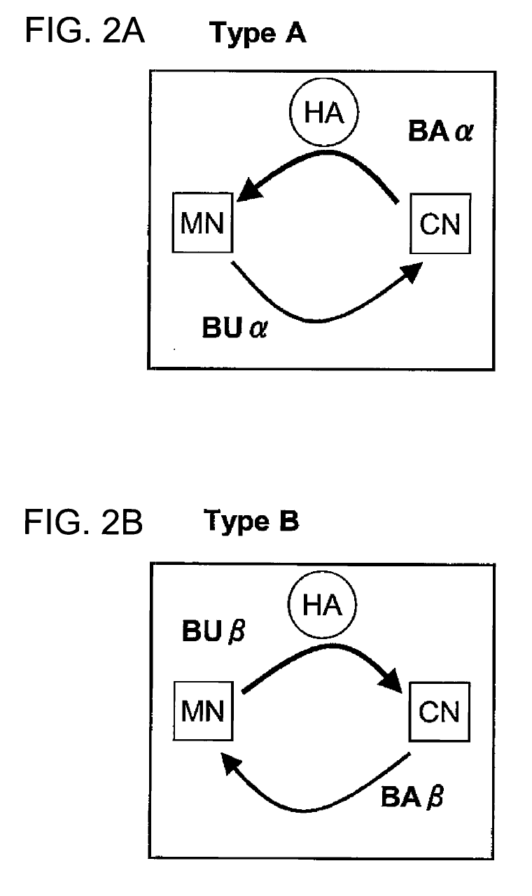

A BU request message and a BU response message pass through different routes because of one-way route optimization (one-way RO). Here, as shown in FIG. 2A and FIG. 2B, a Type A BU request message is referred to as a BUα message, and a Type B BU request message is referred to as a BUβ message. The BU response messages are respectively referred to as a BAα message and a BAβ message. Information used to set the BCE includes the HoA, the CoA, and flag information (transmission RO inapplicability judgment flag) for preventing from transmitting over a RO route.

A message authentication code (MAC) is a piece of information used to authenticate a BU request message. The CN is required to generate a key to check the MAC. Pieces of information used to generate the key are also included in the BU request message. The pieces of information are HoA, CoA, home nonce ID, and care-of nonce ID. These pieces of information are created by one-way return routability (RR) being performed. From these pieces of information, the CN can judge that requested BCE content is checked by one-way RR.

(3) Modification of RR Procedure

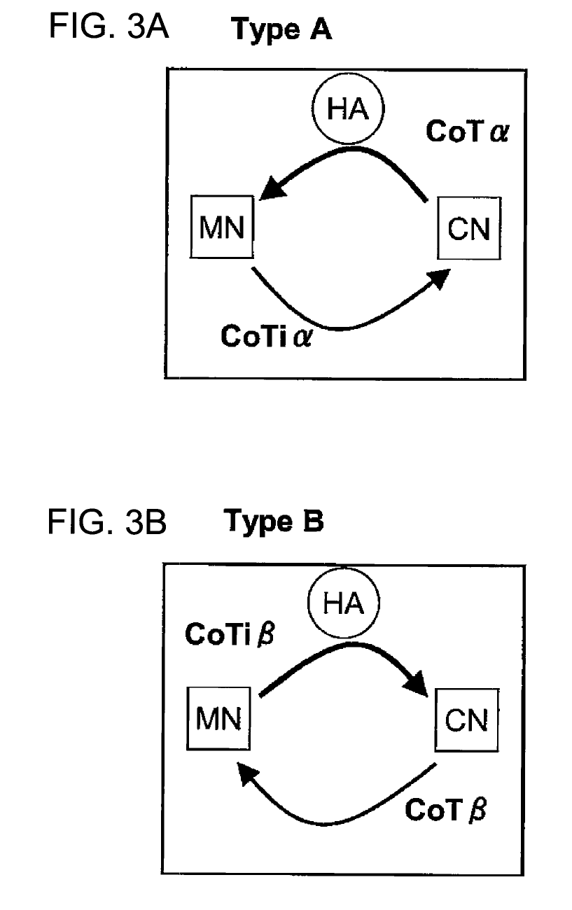

As shown in FIG. 3A and FIG. 3B, a one-way route optimization request message (CoTiα/β message) and a one-way route optimization response message (CoTα/β message) pass through different routes because of one-way route optimization (one-way RO). The one-way route optimization request message (CoTiα/β message) includes information hindering use in reflection attacks. The information is a MAC using a key generated by a home test. The one-way route optimization response message (CoTα/β message) includes a source address of the request message. From the information on the source address, a terminal that receives a reflected message can easily know an address of a reflection source.

### Effects of the Invention

In the conventional MIPv6 binding update, a problem is present in which the route optimization technology cannot be used when communication can be performed in only one direction of a route optimization route and bi-directional communication cannot be performed. The present invention solves this problem, and allows one-way route optimization. In addition, one-way route optimization of the present invention is applied when bi-directional communication can be performed. The present invention can be expected to be used, for example, when bandwidths differ between uplink and downlink, and on an asymmetrical route in which either an amount of uplink data transfer or an amount of downlink data transfer is large for a service of a mobile node.

As a result of the modification to the BCE in (1), described above, a communication device (MN and CN) can perform one-way route optimization. In Type A, optimization can be performed for only data in a direction from the MN to the CN. In Type B, optimization can be performed for only data in a direction from the CN to the MN.

As a result of the modification of the BU procedure in (2), described above, the MN can set a one-way BCE in the CN. In the conventional technology, the BU procedure cannot be completed because the request message or the response message cannot pass. However, the BU procedure can be completed as a result of the present invention. Moreover, because a BCE allowing reflection is set in the one-way BU procedure, whether setting content is suitable is checked by use of the message authentication code in a BU message checking process. As a result of the checking process using the message authentication code, success of the one-way RR procedure can be confirmed.

As a result of the modification of the RR procedure in (3), described above, the MN can acquire information required for the BU message authentication process for performing one-way route optimization. In other words, as a result of the one-way RR procedure, a one-way BU procedure required to set the one-way BCE can be appropriately performed. The response message for the CoTiα/β message is a reflection. Therefore, to hinder an attacker from using the reflection in an attack, the CoTiα/β message includes a message authentication code. In the message authentication code, confirmation can be made that a home test using the HoTi/HoT messages has been performed. In Type A, the home test has been performed on the address (HoA) that is a reflection destination. Therefore, a judgment is made that the response message can be transmitted to the HoA, even through the address of the source of the request message is CoA. In Type B, a terminal receiving a response message can immediately identify the source of the request message as a result of the source address HoA being included in the response message, using a fact that confirmation can be made that the home test has been performed on the terminal at the address HoA of the source of the request message.

### Embodiments

### Overview of a Scenario According to the Embodiments

An MN performs mobile IP return routability (MIP-RR) described in Non-patent Document 1 on a CN. However, the MN switches to one-way route optimization because a response message (CoT) for the transmitted request message (CoTi) is not returned.

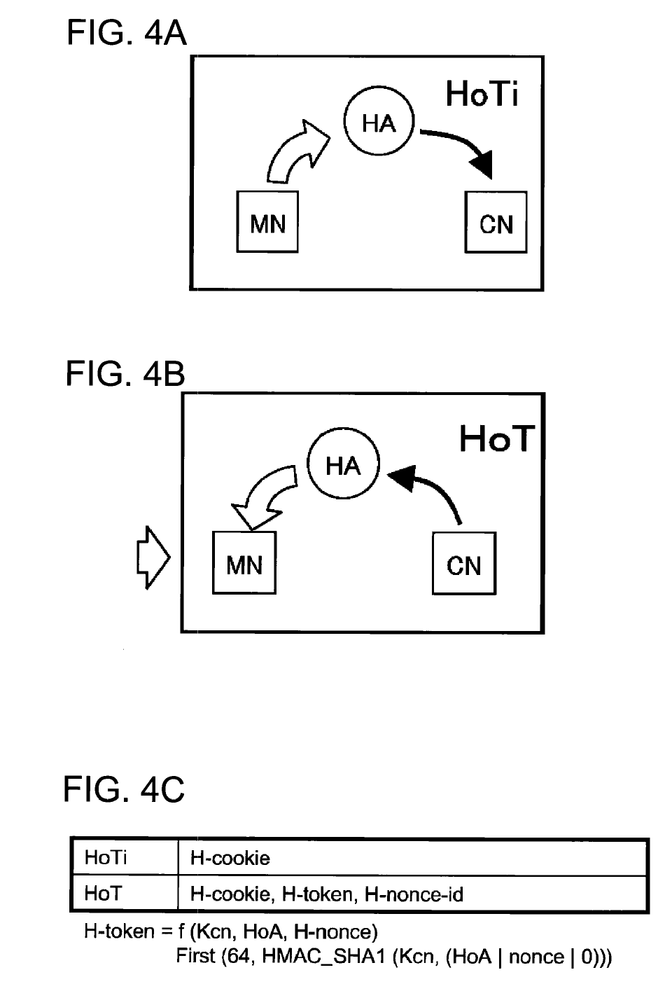

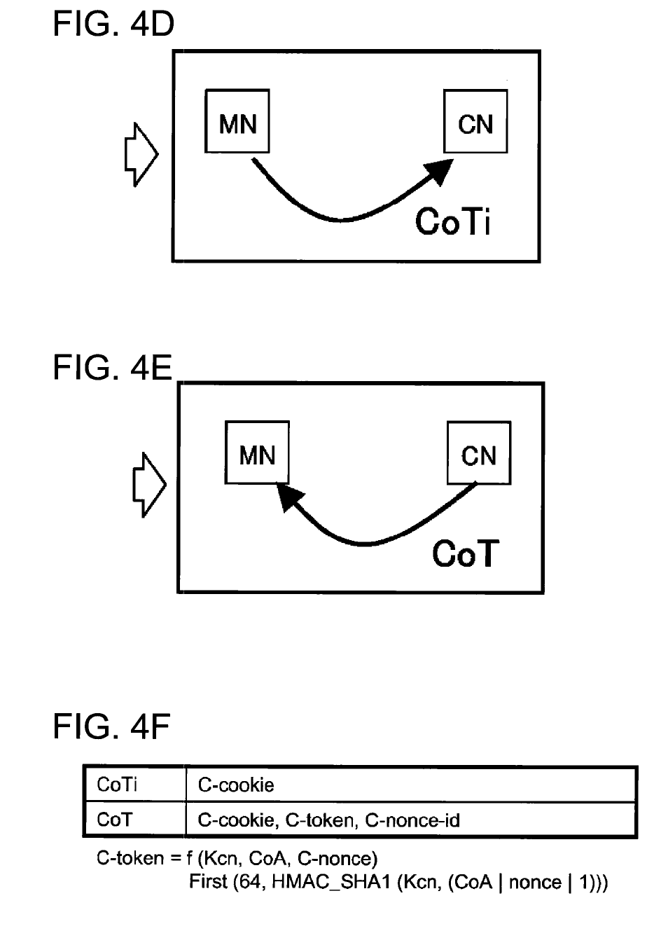

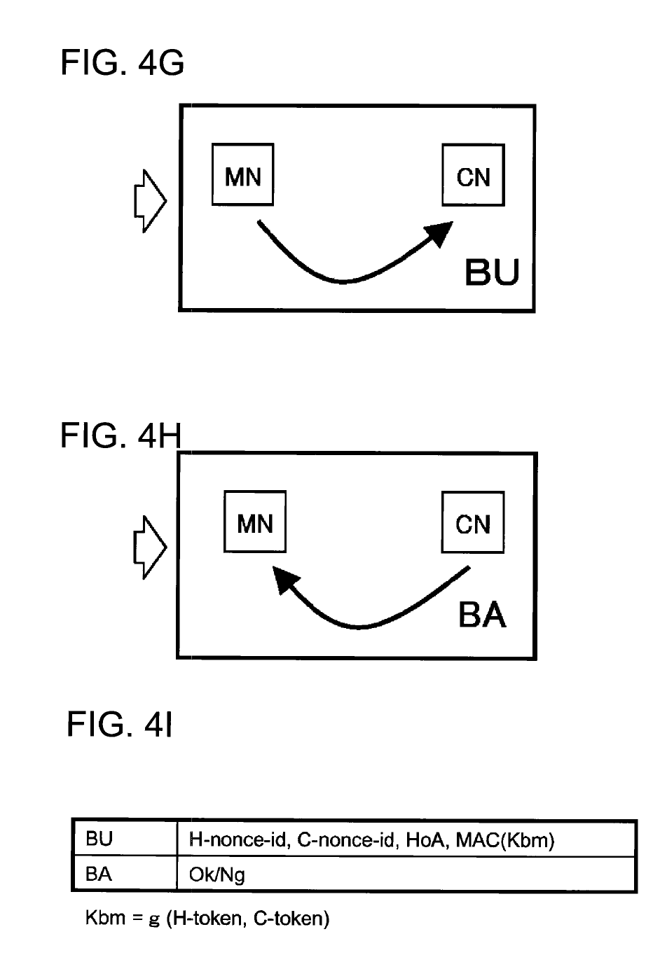

Here, a procedure for MIP-RR that is a conventional technology will be briefly described with reference to FIG. 4A to FIG. 4I.

<HoTi/CoTi>

First, as shown in FIG. 4A and FIG. 4D, the MN transmits a HoTi message and a CoTi message to the CN. As shown in FIG. 4C and FIG. 4F, the messages respectively include a home cookie (H-Cookie in FIG. 4C; the same applies hereafter) and a Care-of Cookie (C-Cookie in FIG. 4F; the same applies hereafter). As shown in FIG. 4C and FIG. 4F, the cookies are respectively inserted into the HoT message and the CoT message that are respective response messages. From the cookie information, the MN that has received the HoT message and the CoT message can identify the request message for which the response message is received.

<HoT/CoT>

When the CN receives the HoTi message, the CN calculates a Home Keygen Token as follows:

Home keygen token:=First(64, HMAC_SHA1(Kcn, (home address|nonce|0)))

Kcn is key data known only by the CN. Home address is a source address of the HoTi message. Nonce is a value that can be uniquely decided by the CN. As shown in FIG. 4B and FIG. 4C, the CN includes identifying information (home nonce ID [H-nonce-id in FIG. 4C; the same applies hereafter]) for identifying the value of the nonce in the HoT message and notifies the MN, such that the MN can know the value of the nonce. Similarly, when the CN receives the CoTi message, the CN calculates a Care-of keygen token as follows:

Care-of keygen token:=First(64, HMAC_SHA1(Kcn, (care-of address|nonce|1)))

As shown in FIG. 4B and FIG. 4C, the CN includes the home cookie, the home keygen token (H-token in FIG. 4C; the same applies hereafter), and the home nonce ID in the HoT message and transmits the HoT message to the MN. In addition, as shown in FIG. 4E and FIG. 4F, the CN includes the care-of cookie, the care-of keygen token (C-token in FIG. 4F; the same applies hereafter), and the care-of nonce ID (C-nonce-id in FIG. 4C; the same applies hereafter) in the CoT message and transmits the CoT message to the MN.

<BU>

When the MN receives the HoT message and the CoT message, the MN generates a key (Kbm) as follows, using the home keygen token and the care-of keygen token.

Kbm=SHA1(home keygen token|care-of keygen token)

The MN generates a MAC of the BU message using the Kbm of generated key, adds the message authentication code to the BU message, and transmits the BU message to the CN, as shown in FIG. 4G and FIG. 4I. The message authentication code is generated as follows:

Authenticator=First(96, HMAC_SHA1(Kbm, Mobility Data)

Mobility Data=care-of address|correspondent|MH data

Authenticator is the message authentication code. The Care-of address is the source address of the BU message. Correspondent is the address of the CN and the destination of the BU message. The MH data is the main body of the BU message.

<BU Authentication/BA>

The MN adds the home nonce ID, the care-of nonce ID, and the home address to the BU message and transmits the BU message. The CN that receives the BU message retrieves the source address, care-of address, and the home nonce from the home nonce ID of the BU message and generates the home keygen token. The CN similarly generates the care-of keygen token. The CN further generates a key (Kbm) from the two tokens. The CN generates a message authentication code using the BU message and the key (Kbm). The CN then checks whether the message authentication code matches the message authentication code added to the BU message by the MN. As a result of the message authentication codes matching, the CN determines that the BU message is a suitable BU message from a communication device (MN) that has performed both the home test (transmits the HoTi message and receives the HoT message) and the care-of test (transmits the CoTi message and receives the CoT message). As shown in FIG. 4H and FIG. 4I, the CN transmits a binding acknowledgement (BA) message to the MN.

A design concept of the RR procedure of the conventional technology is described in Non-patent Document 2. Three points of the design concept are that:
(1) the CN does not hold a state
(2) the response messages are not amplified (amplification is prohibited)
(3) messages are not reflected (reflection is prohibited)

The CN does not hold a state as described in (1) as a defensive measure against DoS attacks launched against the CN. In the process by which the CN receives the HoTi message and returns the HoT message in response, the CN merely calculates the token. The CN is not required to store any piece of information after returning the HoT message. As the value of the Kcn and the value of the nonce, the same values can be used for a plurality of HoTi messages. Therefore, even when the CN simultaneously receives HoTi messages form a plurality of MN, pieces of information required to be held as a result do not increase. The same applies to when the CN receives the CoTi message and transmits the CoT message. When the CN receives the BU message, the CN generates the home keygen token and the care-of token from only the pieces of information included in the BU message. The CN then generates the key (Kbm) from the two tokens. The CN generates the message authentication code of the BU message, and checks whether the generated message authentication code matches the message authentication code added to the BU message.

The response message not being amplified (amplification is prohibited), described in (2), is actualized by division of the home test and the care-of test. For example, a method can be considered in which the MN transmits a single request message to the CN and the CN transmits separate response messages to the HoA and the CoA. However, in this method, an attacker attempting to launch a DoS attack may be provided with a device that doubles the attack message. Therefore, the MIP-RR is designed such that a single response message is returned for a single request message.

The messages not being reflected (reflection is prohibited), described in (3), is actualized by the response message being transmitted to the source address of the request message. In other words, the HoT message is returned to the source of the HoTi message. The CoT message is returned to the source of the CoTi message. Transmission of a response message to an address other than that of the source of the request message allows an attacker to use the CN to attack other communication devices.

The present invention is a technology that actualizes route optimization of a one-way route that was not possible by MIP of the conventional technology. At the same time, the present invention also aims to maintain the three security measures described above. Among these, the CN not holding a state and amplification not being performed are maintained. The reflection not being performed cannot be maintained. However, a new modification is made that prevents use in reflection attacks. Hereafter, the present invention will be described in detail. In a detailed explanation of the present invention, the present invention is described divided into two instances, Type A and Type B, depending on a direction in which the packet flows in one-way route optimization. As described above, Type A refers to when the one-way route optimization is used in the direction from the MN to the CN. Type B refers to when the one-way route optimization is used in the direction from the CN to the MN.

<Type A>

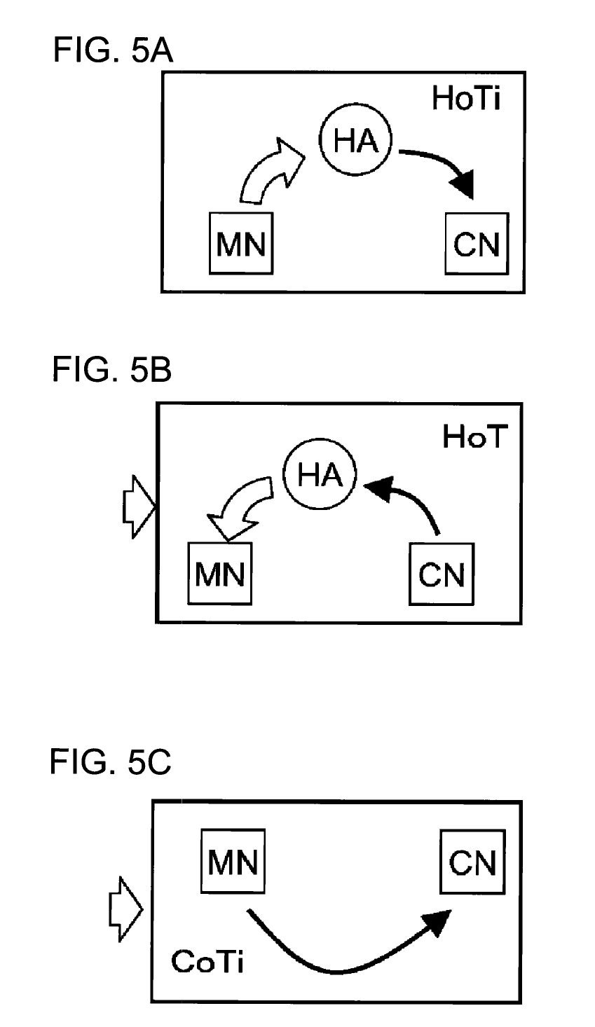

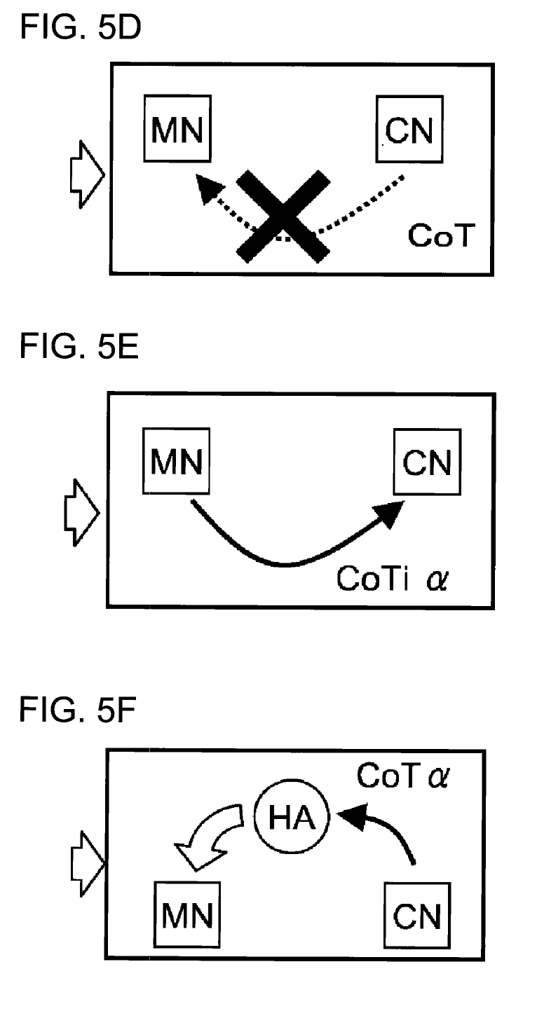

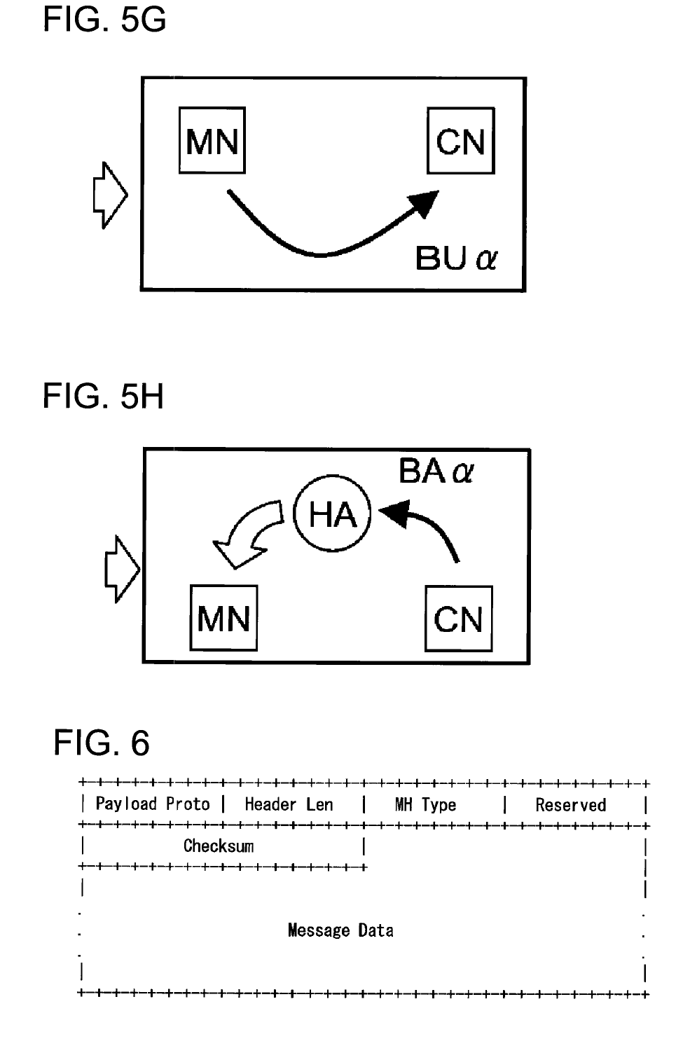

FIG. 5A to FIG. 5H are diagrams of Type A. To perform route optimization of the conventional MIP, the MN transmits the HoTi message (via HA) and the CoTi message (by a direct route) to the CN as respectively shown in FIG. 5A and FIG. 5C. The packet cannot pass through the direct route from the CN to the MN. Therefore, as shown in FIG. 5D, the CoT message does not reach the MN. Therefore, in this instance, the MN is required to end the RR procedure for route optimization at this point.

However, the MN wants to transmit at least data to be transmitted to the CN using an optimized route. The MN starts a Type A one-way RR. As shown in FIG. 5E, the MN transmits a CoTiα message. As shown in FIG. 5F, the CN returns a CoTα message in response. The CoTiα message reaches the CN via the optimized route in a manner similar to the CoT message. On the other hand, unlike the CoT message, the CoTα message is transmitted to the HoA and reaches the MN via the HA. If the CoTα message does not reach the MN, the MN can know that the Type A one-way route optimization cannot be performed. The MN that receives the CoTα message transmits a BUα message as shown in FIG. 5G. As shown in FIG. 5H, the CN sets a BCE corresponding to the one-way RR and returns a BAα message to the MN via the HA.

Next, the messages in one-way RR will be described in detail. In one-way RR, in Type A, a CoTiα message, a CoTα message, a BUα message, and a BAα message are newly defined. In Type B, a CoTiβ message, a CoTβ message, a BUβ message, and a BAβ message are defined. These messages are preferably easily differentiated from the conventional MIP messages.

In the conventional MIP, the CoTi message, the CoT message, the BU message, and the BA message are identified using an MH type format shown in FIG. 6. The MH type is an 8-bit information element in which values from 0 to 7 are already assigned as follows (refer to Non-patent Document 1):
0 Binding Refresh Request
1 Home Test Init
2 Care-of Test Init
3 Home Test
4 Care-of Test
5 Binding Update
6 Binding Acknowledgement
7 Binding Error

Therefore, a method is considered suitable in which each message can be identified by new MH Type values being assigned to the messages newly defined in the one-way RR.

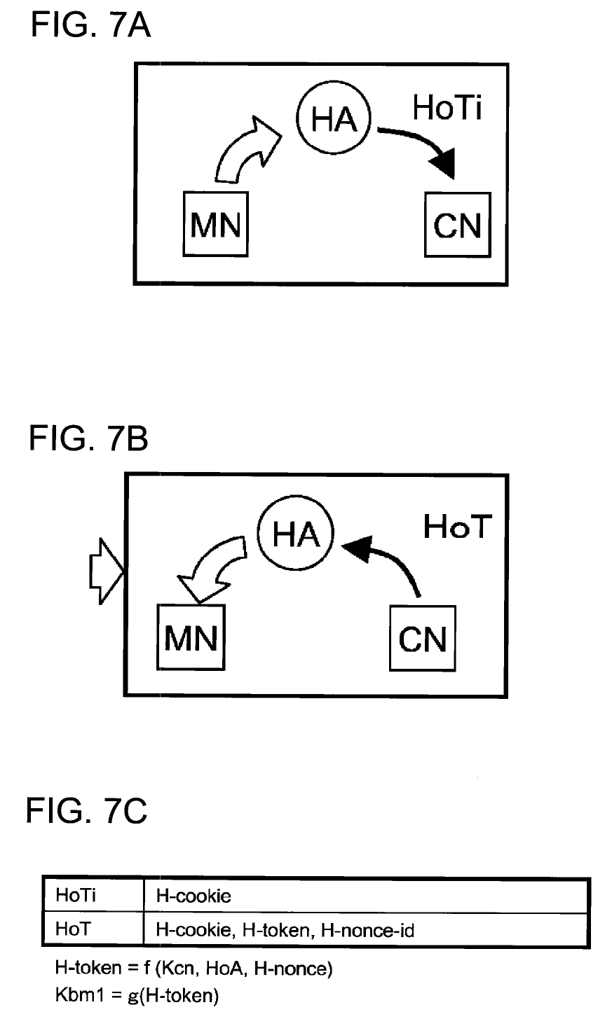

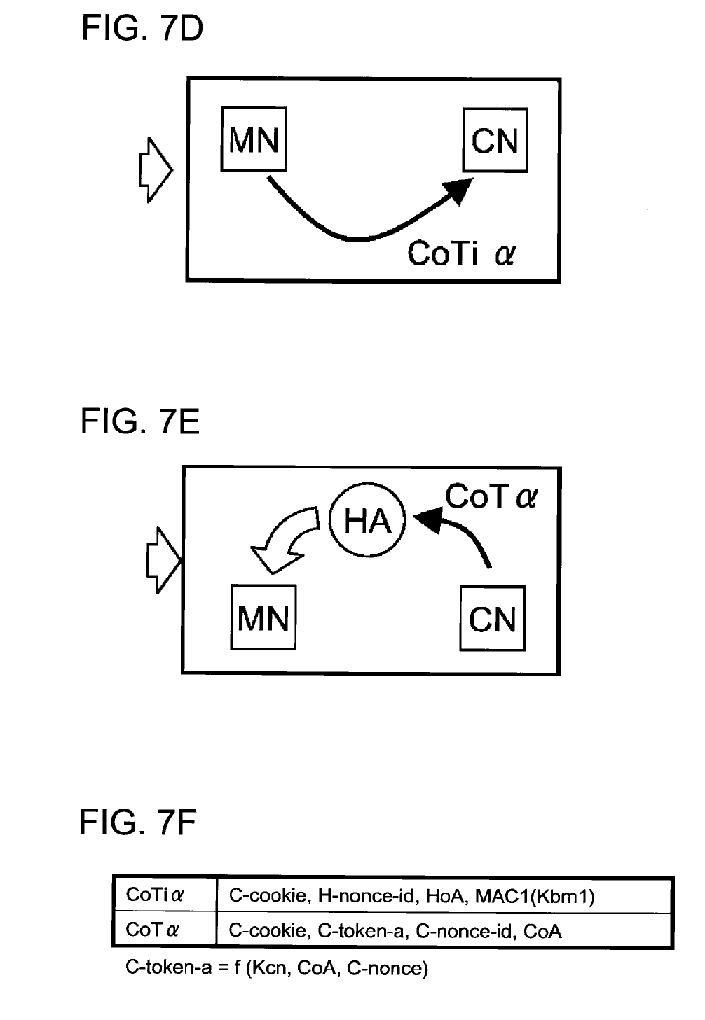

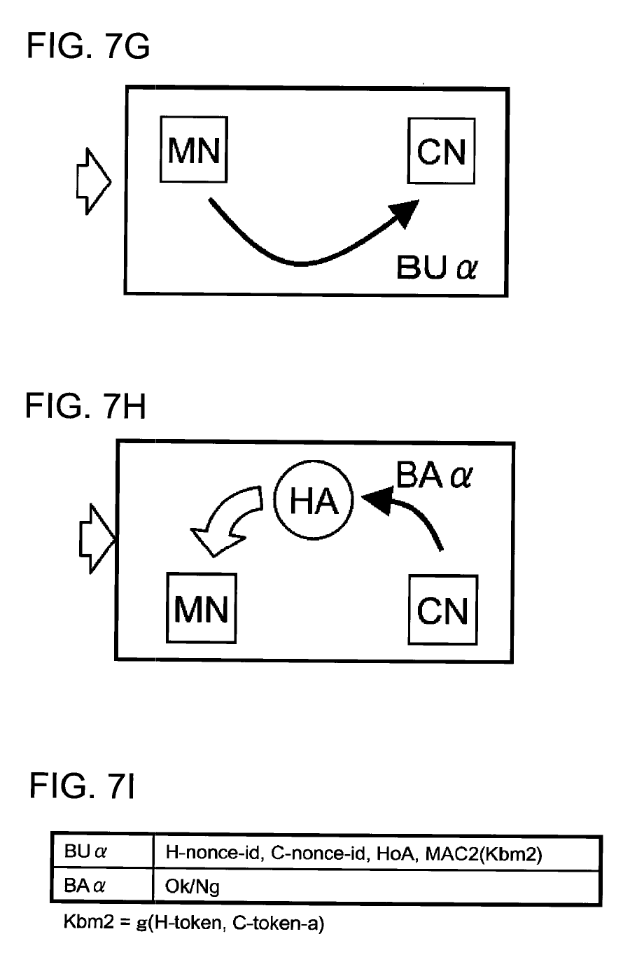

Next, information elements of the messages in the one-way RR will be described with reference to FIG. 7A to FIG. 7I. The HoTi message and the HoT message are the same messages as those in MIP-RR.

<CoTiα>

Unlike the CoT message, the CoTiα message shown in FIG. 7D and FIG. 7F newly includes a home nonce ID, a HoA, and a message authentication code (MAC1(Kbm1), unlike the CoT message. As shown in FIG. 7B and FIG. 7C, the home nonce ID is a value included in the HoT message received by the MN. MAC1 is a message authentication code of the CoTiα message generated using Kbm1. Kbm1 is key data generated using home keygen token included in the HoT message. A method of generating the key is expressed by a following expression.

Kbm1=SHA1(home keygen token)

Moreover, the key Kbm of the MIP is as follows:

Kbm=SHA1(home keygen token|care-of keygen token)

The method of generating the message authentication code is the same as the method of generating the message authentication code of the BU message in MIP.

Authenticator=First(96, HMAC_SHA1(Kbm1, Mobility Data)

Mobility Data=care-of address|correspondent|MH data

The message authentication code (Authenticator) is a calculation result of the key data (Kbm1) and HMAC SHA1 of the Mobility Data. Mobility Data includes the source address (CoA), the destination address (IP address of the CN), and the CoTiα message (MH data).

<CoTiα Authentication>

The CN that receives the CoTiα message retrieves the home nonce from the home nonce ID included in the CoTiα message and, in combination with the HoA, generates the home key token. The CN then generates Kbm1 from the token. The CN generates the message authentication code from Kbm1 and the CoTiα message. The CN checks the CoTiα message by comparing the generated message authentication code with the message authentication code added by the MN. A method of calculating the home keygen token is expressed as follows:

Home keygen token:=First(64, HMAC_SHA1(Kcn,(home address|nonce|0)))

As a result of the message authentication code being checked, the CN can confirm that the terminal transmitting the CoTiα message is a terminal on which the home test has been performed. Reflection refers to transmission of the response message (CoTα message) to the HoA. However, because it can be determined that the destination of the CoTα message and the source of the CoTiα message are the same terminal, the CoTα message is transmitted to the HoA.

<CoTa>

As shown in FIG. 7E and FIG. 7F, the CN includes the CoA in the CoTα message and transmits the CoTα message to the HoA of the MN. The CoA is the source address of the CoTiα message. A terminal that receives the CoTα message can instantly know the address of the reflection source. The terminal transmitting the CoTiα message can easily identify the transmitted request message (CoTiα message) from the received CoTα message, using both a value of a care-of cookie and the CoA. The CN checks the MAC1 and performs reflection to the HoA.

<BUα>

The MN that receives the CoTα message generates key data from a value of a care-of keygen token included in the CoTα message and a value of the home keygen token included in the HoT message as follows:

Kbm2=SHA1(home keygen token|care-of keygen token)

Using the key data Kbm2, the MN generates the message authentication code of the BUα message. As shown in FIG. 7G and FIG. 7I, the MN adds the generated message authentication code to the BUα message and transmits the BUα message to the CN. The BUα message includes the home nonce ID included in the HoT message, the care-of nonce ID included in the CoTα message, and the HoA. The message authentication code of the BUα message is generated as follows:

Authenticator=First(96, HMAC_SHA1(Kbm2, Mobility Data))

Mobility Data=care-of address|correspondent|MH Data

Authenticator is the message authentication code. Care-of address is the source address of the BUα message. Correspondent is the destination address. MH Data is a main body of the BUα message.

<BUα Authentication>

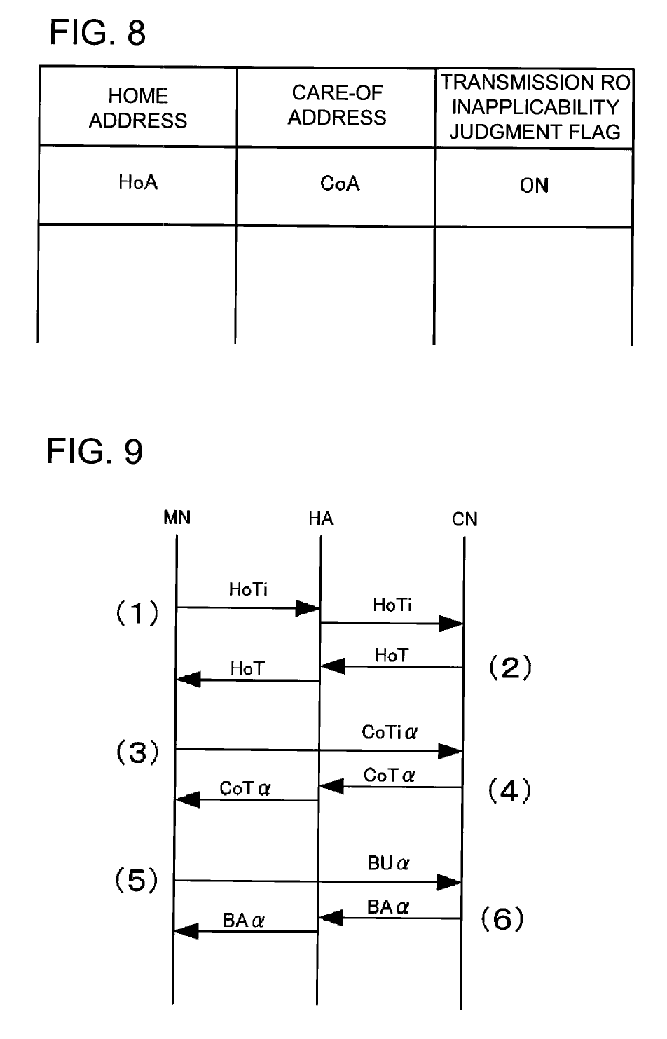

The CN receives the BUα message, generates the home keygen token from the home nonce ID and the home address, and generates the care-of keygen token using the care-of nonce ID and the care-of address that is the source address. The CN then generates Kbm2 using the two tokens, generates the message authentication code of the BUα message, and checks whether the generated message authentication code matches the added message authentication code. When the message authentication code matches, the CN sets the one-way BCE. Information that is the “transmission RO inapplicability judgment flag” is included in the one-way BCE. For example, the BCE is as shown in FIG. 8 because the home address of the MN is the HoA, the care-of address is the CoA, and the “transmission RO inapplicability judgment flag” is ON because the BCE to be registered at this time is the one-way RO.

As A result of a BCE such as that above being set, the CN transmits a packet addressed to the HoA address without performing a RO process on the packet. The RO process refers to a process in which a routing header is added to the packet address to the HoA, the destination address is changed to the CoA, and the packet is transmitted.

A message sequence in the Type A one-way RR procedure is shown in FIG. 9. In FIG. 9,
(1) the MN transmits the HoTi message to the CN via the HA,
(2) the CN transmits the HoT message to the MN via the HA in response to the HoTi message,
(3) the MN transmits the CoTiα message directly to the CN,
(4) the CN authenticates the CoTiα message and transmits the CoTα message to the MN via the HA,
(5) the MN transmits the BUα message directly to the CN, and
(6) the CN authenticates the BUα message and transmits the BAα message to the MN via the HA.

The Type A one-way RR process is as described above.

<Type B>

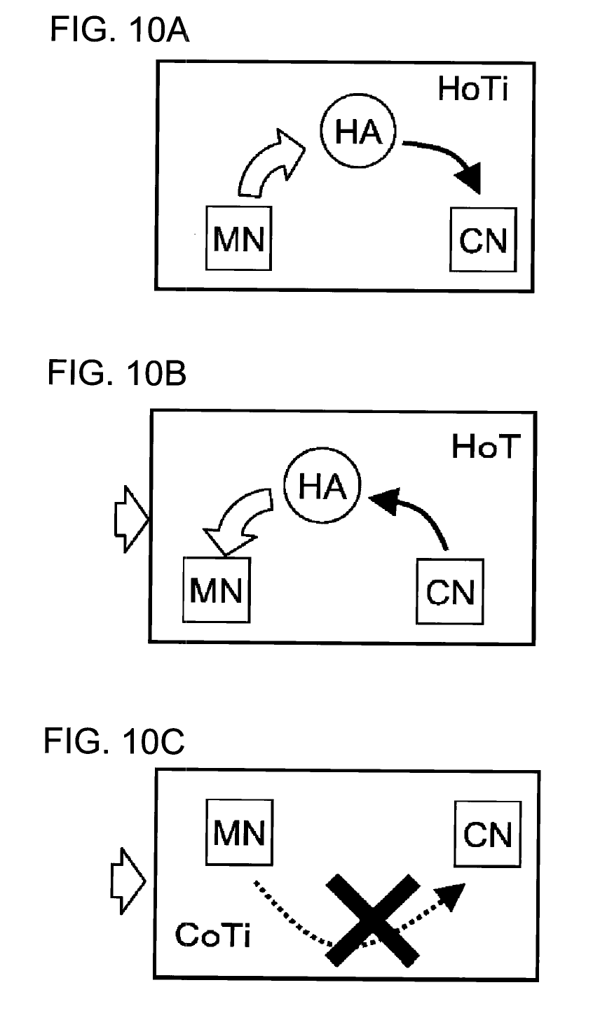

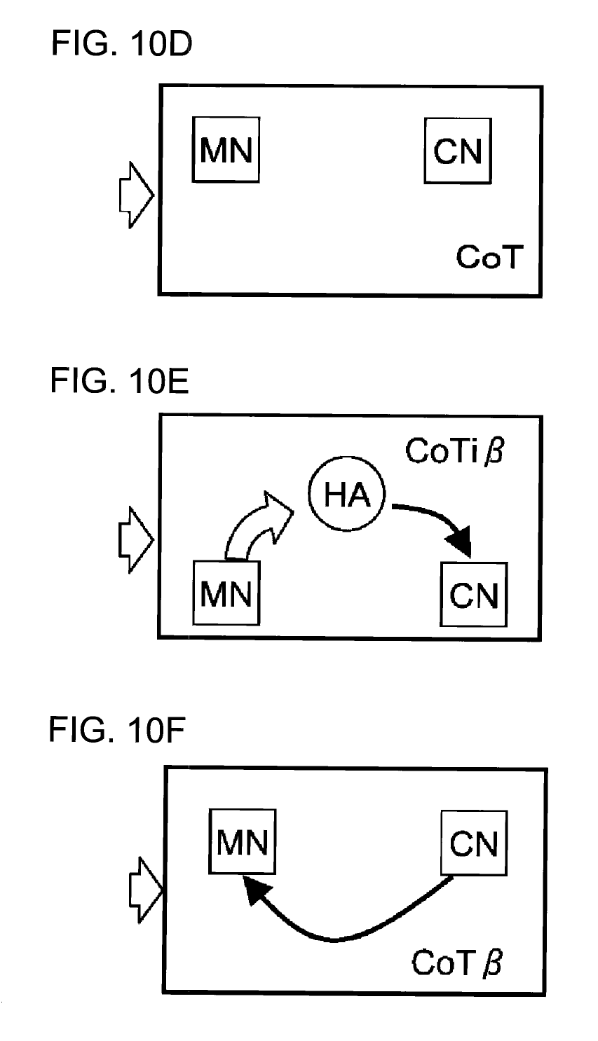

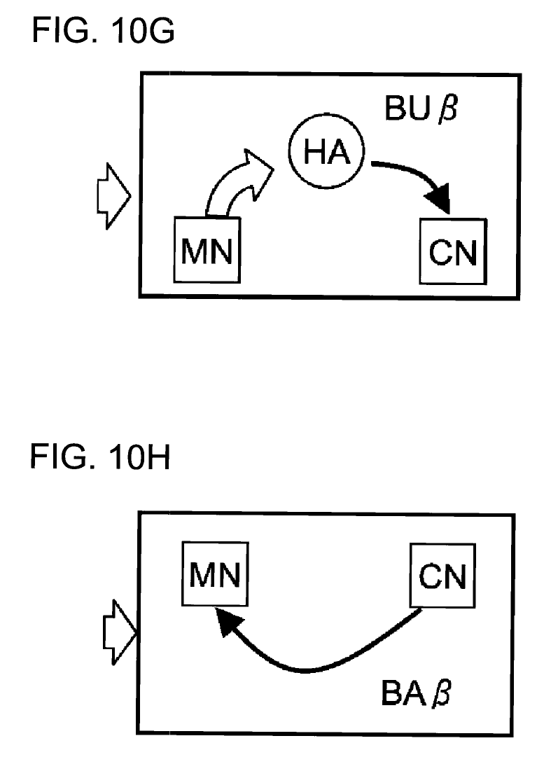

FIG. 10A to FIG. 10H are diagrams of a Type B one-way RR process. As in Type A, in Type B, the MN transmits the HoTi message and the CoTi message to the CN, as shown in FIG. 10A and FIG. 10C, to perform route optimization of the conventional MIP. In Type B, packets cannot pass through a direct route from the CN to the MN, as shown in FIG. 10C and FIG. 10D. Therefore, the CoT message does not reach the MN. In the conventional technology, the RR process ends at this point. The MN wants to transmit at least data to be transmitted from the CN to the MN over an optimized route, and starts the Type B one-way RR. As shown in FIG. 10E, the MN transmits the CoTiβ message. As shown in FIG. 10F, the CN returns the CoTβ message in response. Unlike the CoTi message, the CoTiβ message is transmitted via the HA with the HoA as the source address. On the other hand, the CoTβ message is transmitted over a route optimization route in the same manner as the CoT message. If the CoTβ message does not reach the MN, the MN can know that the Type B one-way route optimization cannot be performed. The MN that receives the CoTβ message transmits the BUβ message as shown in FIG. 10G. The CN sets the BCE corresponding to the one-way RR, and returns the BAβ message as shown in FIG. 10H.

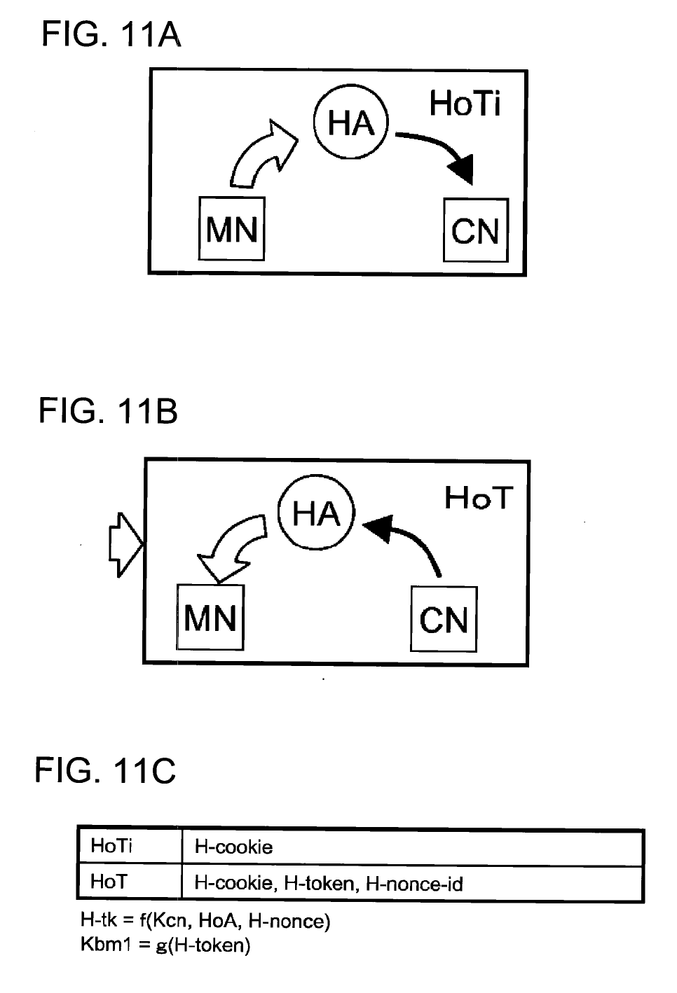

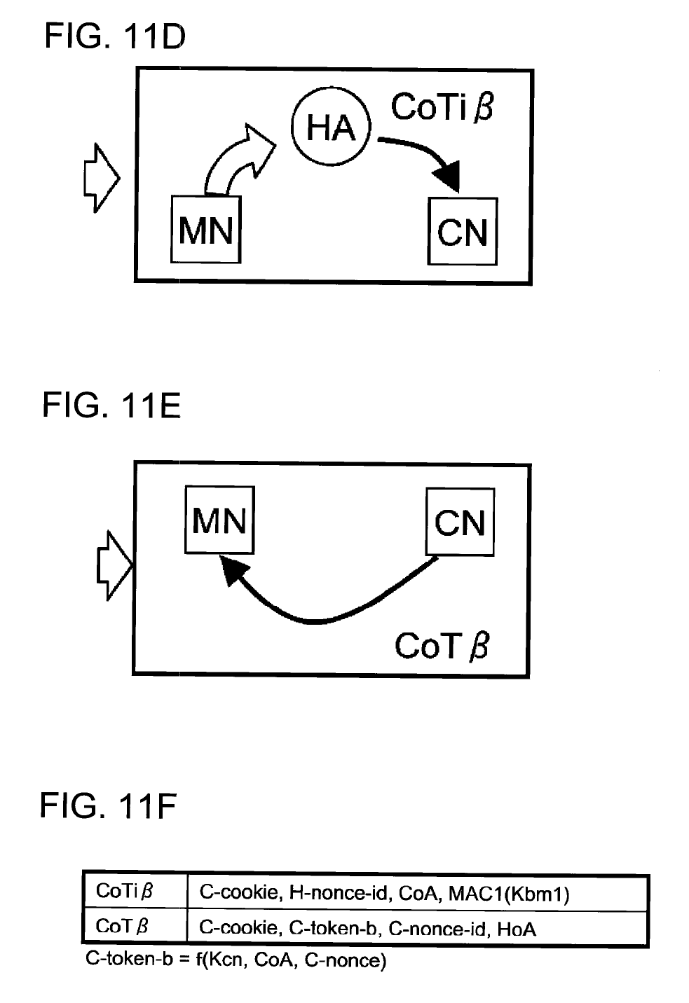

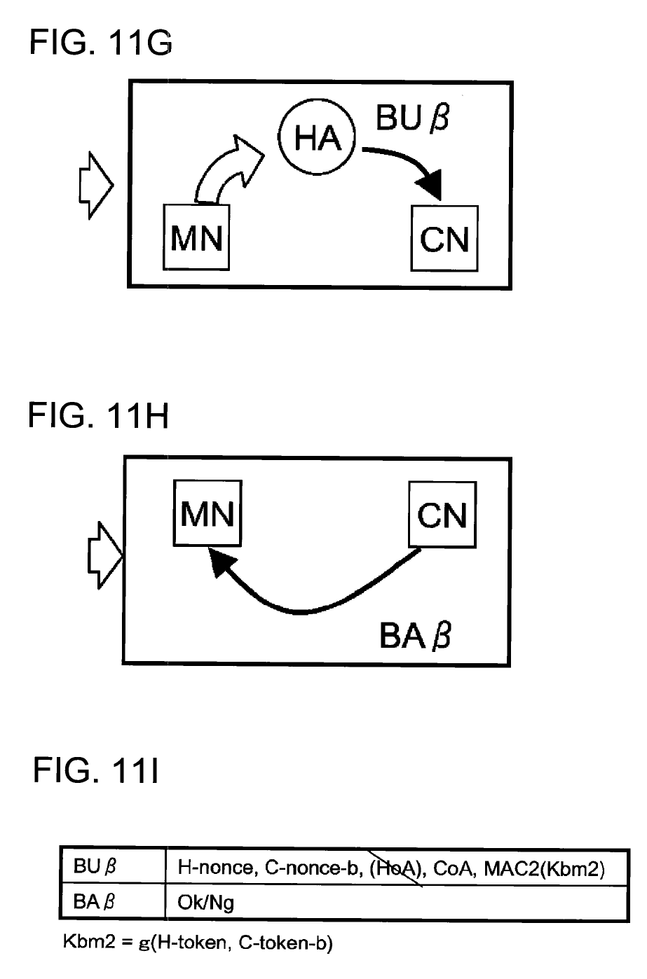

Next, the details of the messages in the one-way RR will be described with reference to FIG. 11A to FIG. 11I. As shown in FIG. 11A to FIG. 11C, the HoTi message and the HoT message are the same messages as those in MIP-RR.

<CoTiβ>

As shown in FIG. 11D and FIG. 11F, unlike the CoT message, the CoTiβ message newly includes the home nonce ID, the CoA, and the message authentication code (MAC1(Kbm1)). The home nonce ID is a value included in the HoT message received by the MN. MAC1 is the message authentication code of the CoTiα message generated using Kbm1. Kbm1 is key data generated using the home keygen token included in the HoT message. A method of generating the key is expressed by a following expression:

Kbm1=SHA1(home keygen token)

A method of generating the message authentication code is expressed by a following expression:

Authenticator=First(96, HMAC_SHA1(Kbm1, Mobility Data)

Mobility Data=home address|correspondent|MH data

The message authentication code is a calculation result of the key data (Kbm) and HMAC SHA1 of the Mobility Data. Mobility Data includes the source address (HoA) and the destination address (IP address of the CN) of the CoTiβ message, and a main body of the CoTiβ message (MH data).

<CoTiβ Authentication>

The CN that receives the CoTiβ message retrieves the home nonce from the home nonce ID included in the CoTiβ message and, in combination with the HoA, generates the home key token. The CN then generates Kbm1 from the token. The CN generates the message authentication code from Kbm1 and the CoTiβ message. The CN checks the CoTiβ message by comparing the generated message authentication code with the message authentication code added by the MN.

As a result of the message authentication code being checked, the CN can confirm that the terminal transmitting the CoTiβ message is a terminal on which the home test has been performed. Unlike in Type A, an address of a reflection destination cannot be confirmed. However, the source address of the CoTiβ message can be confirmed. Moreover, the terminal receiving the CoTβ message can know the address of the reflection source as a result of the HoA being included in the CoTβ message that is the response message. The address of the reflection source can be checked by the message authentication code. Therefore, even should an attacker attempt to launch a reflection attack using the CoTiβ message, the CoTiβ message is difficult for the attacker to use because the attacker is required to perform the home test in advance and the address (HoA) of the attacker itself will become known.

<CoTα>

As shown in FIG. 11E and FIG. 11F, the CN includes the HoA in the CoTβ message and transmits the CoTβ message to the CoA of the MN. The HoA is the source address of the CoTiβ message. A terminal that receives the CoTβ message can instantly know the address of the reflection source. The terminal transmitting the CoTiβ message can identify the transmitted request message (CoTiβ message) from the received CoTβ message, using both a value of a care-of cookie and the HoA. The CN checks the MAC1 and performs reflection to the CoA.

<BUα>

The MN that receives the CoTβ message generates key data (Kbm2) from a value of a care-of keygen token included in the CoTβ message and a value of the home keygen token included in the HoT message.

Kbm2=SHA1(home keygen token|care-of keygen token)

Using the key data Kbm2, the MN generates the message authentication code of the BUβ message. As shown in FIG. 11G and FIG. 11I, the MN adds the generated message authentication code to the BUβ message and transmits the BUβ message to the CN. The BUβ message includes the home nonce ID included in the HoT message, the care-of nonce ID included in the CoTβ message, and the care-of address in place of the HoA. The message authentication code of the BUβ message is generated as follows:

Authenticator=First(96, HMAC_SHA1(Kbm2, Mobility Data))

Mobility Data=home address|correspondent|MH Data

Authenticator is the message authentication code. Home address is the source address of the BUβ message. Correspondent is the destination address. MH Data is a main body of the BUβ message.

<BUβ Authentication>

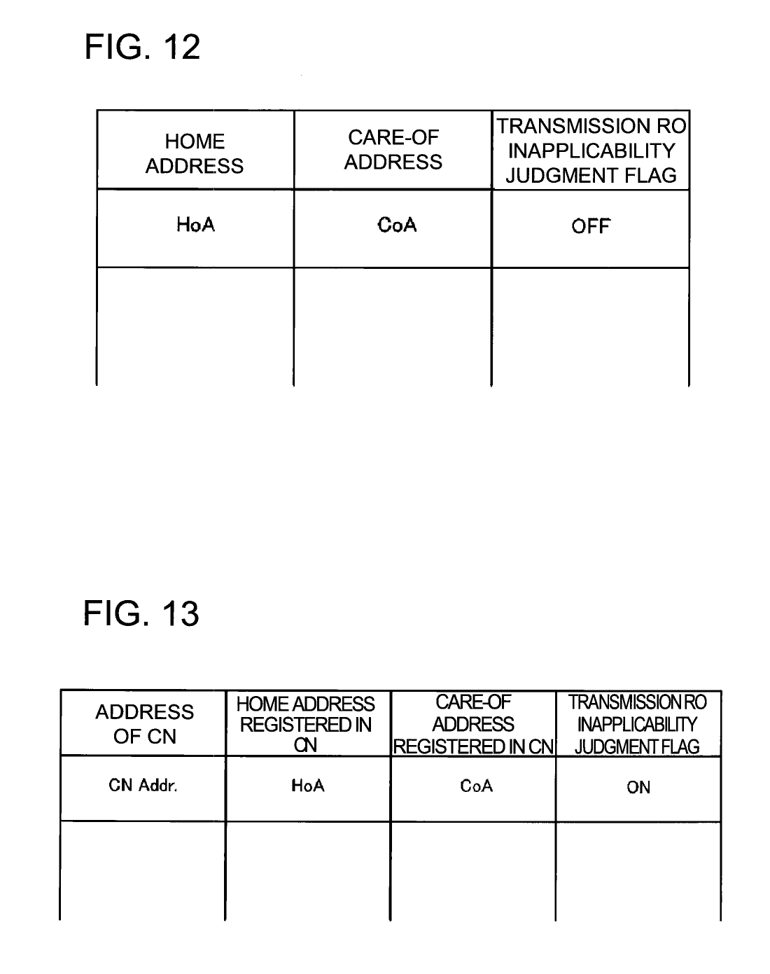

The CN receives the BUβ message, generates the home keygen token from the home nonce ID and the home address that is the source address, and generates the care-of keygen token using the care-of nonce ID and the care-of address included in the BUβ message. The CN then generates Kbm2 using the two tokens, generates the message authentication code of the BUβ message, and checks whether the generated message authentication code matches the added message authentication code. When the message authentication code matches, the CN sets the one-way BCE. In Type B, the BCE registered by the CN can be the same as an ordinary MIP-BCE, and is as shown in FIG. 12 (transmission RO inapplicability judgment flag is OFF).

On the other hand, the transmission RO inapplicability judgment flag (=ON) is required to be set in the one-way BCE held by the MN, as shown in FIG. 13. When the MN transmits the packet over an optimized route, the MN adds the home address option to the packet, changes the source address from the HoA to the CoA, and transmits the packet. When the “transmission RO inapplicability judgment flag” is ON as in the above-described one-way BCE, the MN transmits the packet to the CN via the HA with the HoA remaining as the source address.

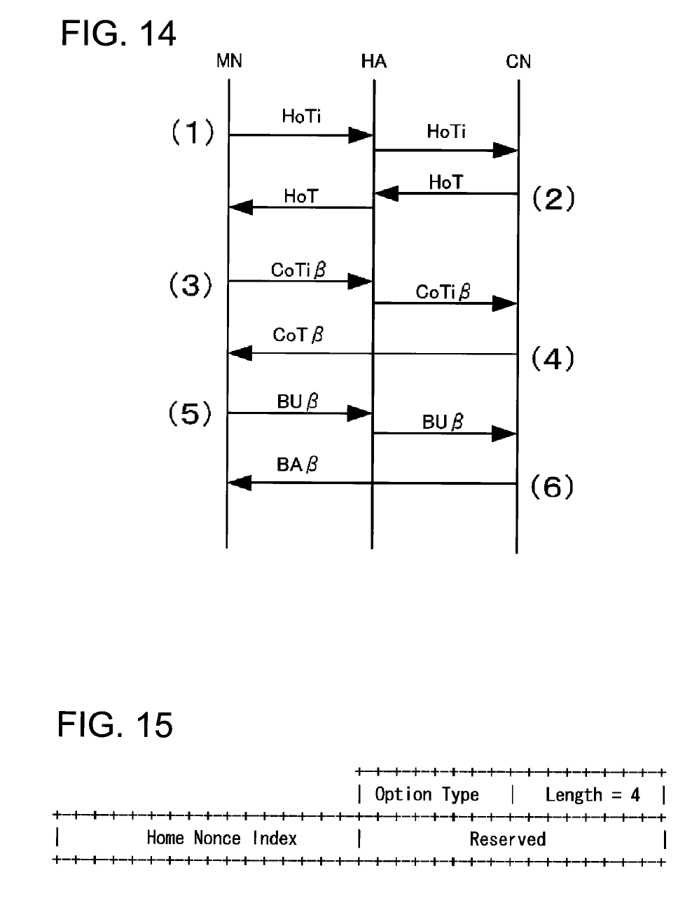

A message sequence in the Type B one-way RR procedure is shown in FIG. 14. In FIG. 14,
(1) the MN transmits the HoTi message to the CN via the HA,
(2) the CN transmits the HoT message to the MN via the HA in response to the HoTi message,
(3) the MN transmits the CoTiβ message to the CN via the HA,
(4) the CN authenticates the CoTiβ message and transmits the CoTβ message directly to the MN,
(5) the MN transmits the BUβ message to the CN via the HA, and
(6) the CN authenticates the BUβ message and transmits the BAβ message directly to the MN.

The Type B one-way RR process is as described above.

<Message Format>

Next, message formats will be described. The CoTiα message, the CoTα message, the CoTiβ message and the CoTβ message of the present invention add new information elements to the known CoTi message and CoT message. The added information elements are the home nonce ID, the home address, the care-of address, and the MAC (Kbm1). As a format for storing the information elements, a message format defined in MIP (RFC 3775) can be used as is. Alternatively, the message format can be used with slight modifications made thereto.

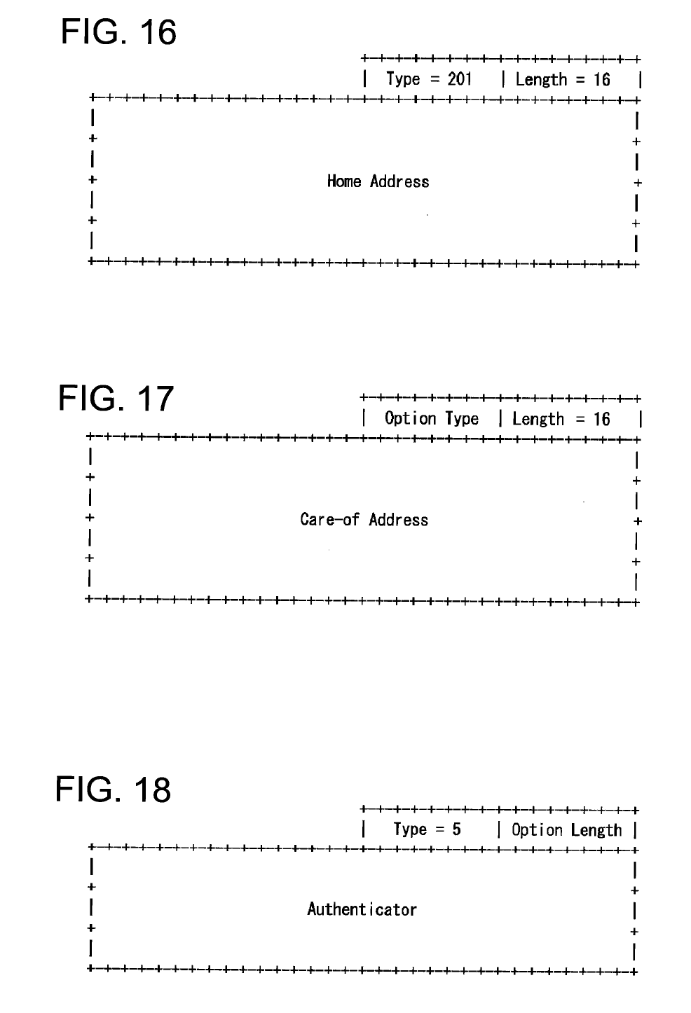

Home nonce ID: In RFC 3775, a mobility option carrying only a home nonce index is not defined. Therefore, as shown in FIG. 15, a new option type is required to be defined.
Home address: In RFC 3775, the home address option is already defined as shown in FIG. 16. Therefore, this home address option can be used.
Care-of address: In RFC 3775, the care-of address option is not present. Therefore, as shown in FIG. 17, a new option type is required to be defined. A method can also be considered in which an alternate CoA option is converted.
MAC (Kbm1): In RFC 3775, the mobility option of the message authentication code added to the BU is defined, as shown in FIG. 18. Therefore, the mobility option can be used.

<Configuration of CN>

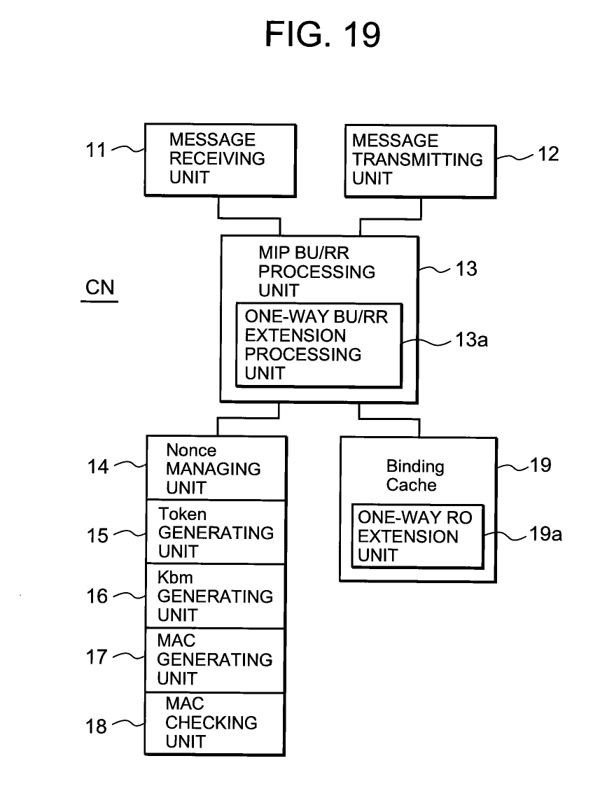

FIG. 19 is a block diagram of a configuration of a message processing unit of the CN. The CN performs transmission and reception of messages as follows:
(1) receives the HoTi message and transmits the HoT message,
(2) receives the CoTi message and transmits the CoT message,
(3) receives the CoTiα message, authenticates the CoTiα message, and transmits the CoTα message,
(4) receives the CoTiβ message, authenticates the CoTiβ message, and transmits the CoTβmessage,
(5) receives the BU message, authenticates the BU message, and transmits the BA message,
(6) receives the BUα message, authenticates the BUα message, and transmits the BAα message, and
(7) receives the BUβ message, authenticates the BUβ message, and transmits the BAβ message.

The message receiving and transmitting processes in (1), (2), and (5) are performed in an MIP BU/RR processing unit 13 (and a message receiving unit 11 and a message transmitting unit 12). The message receiving and transmitting processes in (3), (4), (6), and (7) are performed in a one-way BU/RR extension processing unit 13a (and the message receiving unit 11 and the message transmitting unit 12). When the token and the nonce ID are added to the message in the transmitting process of the HoT message, the CoT message, the CoTα message, and the CoTβ message, data is obtained by a nonce managing unit 14 and a token creating unit 15. The token creating unit 15 obtains the value of the nonce from the nonce managing unit 14, and calculates the value of the token using the address and key data Kcn obtained from the received request message. The nonce managing unit 14 sends the value of the nonce ID corresponding to the value of the nonce sent to the token creating unit 15 to the MIP BU/RR processing unit 13.

When the message authentication code is created and authenticated in the receiving process of the CoTiα message and the CoTiβ message, the home nonce ID included in the CoTiα message and the CoTiβ message is sent to the nonce managing unit 14, and the value of the nonce is obtained. The obtained value of the nonce and the address (HoA) included in the message is sent to the token creating unit 15, and the value of the token is obtained. The obtained value of the token is sent to a Kbm creating unit 16, and the Kbm is generated. The generated Kbm and the received message are sent to a MAC creating unit 17, and the value of the MAC is calculated. The calculated value of the MAC is compared with the value of the MAC included in the CoTiβ message. A MAC checking unit 18 checks whether the values of the MAC match.

When the message authentication code is created and checked (authenticated) in the receiving process of the BU message, the BUα message, and the BUβ message, the home nonce ID and the care-of nonce ID included in the BU message, the BUα message, and the BUβ message are sent to the nonce managing unit 14, and respective values of the nonce are obtained. The obtained values of the nonce, and the home address and the care-of address included in the BU message, the BUα message, and the BUβ message are each sent to the token creating unit 15, and the home keygen token and the care-of keygen token are generated. The two obtained tokens are sent to the Kbm creating unit 16, and the Kbm is generated. The generated Kbm and the received message are sent to the MAC creating unit 17, and the value of the MAC is calculated. The calculated value of the MAC is compared with the MAC included in the BU message, the BUα message, and the BUβ message, and the MAC checking unit 18 checks whether the values of the MAC match. When the MAC check is successful, the correspondence between the home address and the care-of address is registered in a binding cache 19. In the BUα message, the transmission RO inapplicability judgment flag (see FIG. 8) is set in a one-way RO extension unit 19a.

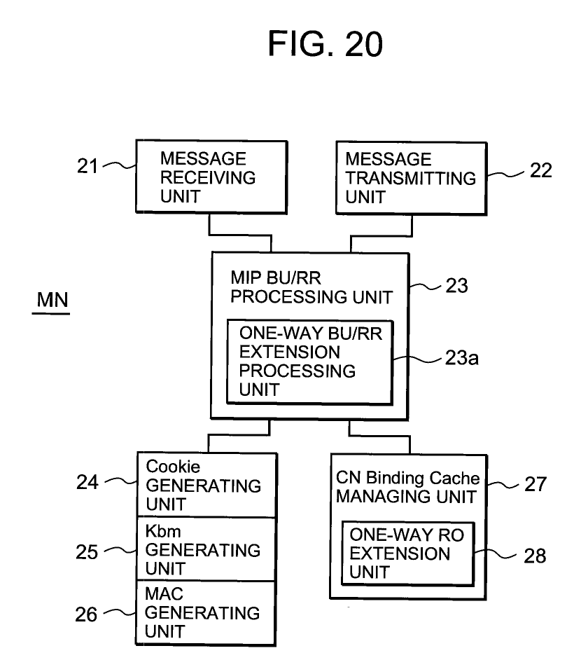

FIG. 20 is a block diagram of a configuration of a message processing unit of the MN. The MN performs transmission and reception of messages as follows:
(1) transmits the HoTi message and receives the HoT message,
(2) transmits the CoTi message and receives the CoT message,
(3) transmits the CoTiα message including the message authentication code and receives the CoTα message,
(4) transmits the CoTiβ message including the message authentication code and receives the CoTβ message,
(5) transmits the BU message including the message authentication code and receives the BA message,
(6) transmits the BUα message including the message authentication code and receives the BAα message, and
(7) transmits the BUβ message including the message authentication code and receives the BAβ message.

The message receiving and transmitting processes in (1), (2), and (5) are performed in an MIP BU/RR processing unit 23 (and a message receiving unit 21 and a message transmitting unit 22). The message receiving and transmitting processes in (3), (4), (6), and (7) are performed in a one-way BU/RR extension processing unit 23a. In the transmitting process of the HoTi message, the CoTi message, the CoTiα message, and the CoTβ message, a value of a cookie created by a cookie creating unit 24 is inserted into the HoTi message, the CoTi message, the CoTiα message, and the CoTiβ message. In the transmitting process of the CoTiα message and the CoTiβ message, the message authentication code is created and added to the message. In this instance, the home keygen token is obtained from the received HoT message. The obtained home keygen token is sent to the Kbm creating unit 25, and the Kbm is generated. A MAC creating unit 26 calculates the MAC using the created Kbm and the CoTiα message and the CoTiβ message to be transmitted. The calculated MAC is added to the CoTiα message and the CoTiβ message, and the CoTiα message and the CoTiβ message are transmitted.

In the transmitting process of the BU message, the BUα message, and the BUβ message, as well, the message authentication code is created and added to the message. In this instance, the home keygen token is obtained from the received HoT message, and the care-of keygen token is obtained from the CoT/CoTα/CoTβ message. The home keygen token and the care-of keygen token are each sent to the Kbm creating unit 25, and the Kbm is generated. The MAC creating unit 26 calculates the MAC using the created Kbm and the BU message, the BUα message, and the BUβ message to be transmitted. The calculated MAC is added to the BU message, the BUα message, and the BUβ message, and the BU message, the BUα message, and the BUβ message are transmitted. A CN binding cache managing unit 27 manages the binding cache in the CN. The transmission RO inapplicability judgment flag (FIG. 13) is set in a one-way RO extension unit 28.

### Other Usage Example 1

### Overview of a Scenario of Another Usage Example 1

The MN initially wants for one-way route optimization to be performed, and starts the one-way RR procedure. According to the above-described embodiment, after the MN receives the CoTi message, the MN transmits the CoTiα message or the CoTiβ message because the CoT message is not received. However, the MN can transmit the CoTiα message or the CoTiβ message for the purpose of performing one-way route optimization, without initially transmitting the CoTi message.

### Other Usage Example 2

### Overview of a Scenario of Another Usage Example 2

When the MN is a terminal holding a plurality of interfaces, the MN performs the one-way RO even when the home agent is not present. For example, the MN has two interfaces. The tow interfaces are, for example, an interface connecting to a mobile phone network and an interface for receiving digital terrestrial television broadcasting. An address assigned to the mobile phone network-side interface is IP (mobile), and an address assigned to the digital terrestrial television broadcast-side interface is IP (broadcast). The IP (mobile) is an address that can perform bi-directional communication. On the other hand, the IP (broadcast) can only be used for downlink communication. At this time, a mobile phone can perform the Type B one-way route optimization procedure with the IP (mobile) as the HoA and the IP (broadcast) as the CoA. As an example in which the Type A one-way route optimization procedure is performed, a terminal of a digital terrestrial broadcasting station can be considered. The terminal on the broadcasting station side can hold an interface for uplink only. The interface can be used in one-way route optimization.

### Other Usage Example 3

### Overview of a Scenario of Another Usage Example 3

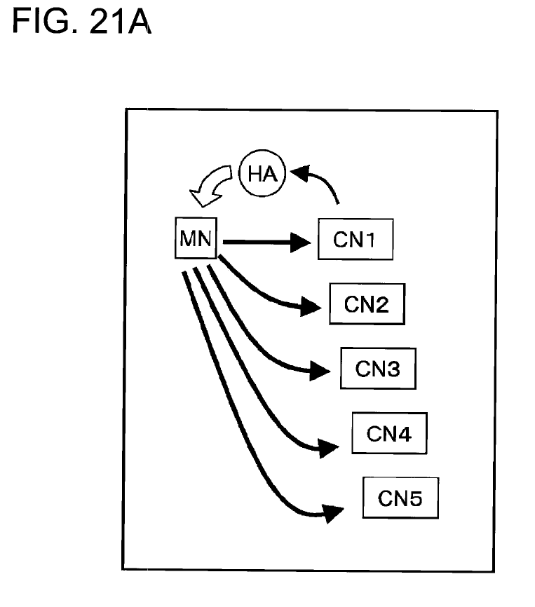

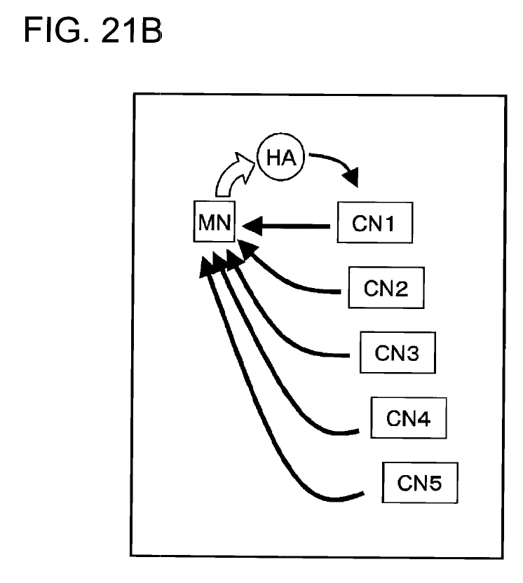

As shown in FIG. 21A and FIG. 21B, the MN performs one-way route optimization with a plurality of CN (CN1 to CN5).

### Type A:

When the MN has a wide-band interface for broadcasting and a narrow-band interface capable of bi-directional communication, as shown in FIG. 21A, a usage can be considered in which one-way route optimization (Type A) is performed for a plurality of CN1 to CN5.

### Type B:

When the MN has an interface capable of bi-directional communication and an interface for broadcasting dedicated to downloading, as shown in FIG. 21B, a usage can be considered in which one-way route optimization (Type B) is performed for a plurality of CN1 to CN5.

As described above, in the present invention, the return routability procedure can be performed for performing one-way route optimization without the CN holding a state. Message amplification can also be avoided. Moreover, possibility of expected reflection attacks can be reduced.

Each functional block used in the explanations of the embodiment of the present invention, described above, can be actualized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the integrated circuit (IC), a system LSI, a super LSI, or an ultra LSI. The method of forming the integrated circuit is not limited to LSI and can be actualized by a dedicated circuit or a general-purpose processor. A field programmable gate array (FPGA) that can be programmed or a reconfigurable processor of which connections and settings of the circuit cells within the LSI can be reconfigured can be used after LSI manufacturing. Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

### INDUSTRIAL APPLICABILITY

The present invention achieves an effect in which the return routability process and the binding update can be performed to allow actualization of route optimization, while maintaining security on a one-way route and an asymmetrical route to a degree similar to that achieved by conventional technology. RFC 3775 “Mobility Support in IPv6”, RFC 4225 “Mobile IP Version 6 Route Optimization Security Design Background”, and the like can be used.

1. A communication method for performing route optimization for performing communication between a mobile node and a correspondent node by a direct route, without passing through a home agent of the mobile node, comprising a step of:
one-way route optimization at which communication is performed on a one-way direct route in only a direction from the mobile node to the correspondent node,
the one-way route optimization including
a home address test step at which the mobile node transmits a first request message to the correspondent node via the home agent, and the correspondent node responds to the first request message and transmits a first response message including message authentication code generation information to the mobile node via the home agent,
a care-of address test step at which the mobile node generates a first message authentication code from the message authentication code generation information within the first response message and transmits a second request message including the first message authentication code to the correspondent node via the one-way direct route, and the correspondent node authenticates the first message authentication code and transmits a second response message including a care-of address of the mobile node to the mobile node via the home agent, and
a binding update authentication step at which the mobile node generates a second message authentication code from the care-of address of the mobile node within the second response message and transmits a binding update message including the second message authentication code to the correspondent node via the one-way direct route, and the correspondent node authenticates the second message authentication code and transmits a binding confirmation message to the mobile node via the home agent.

2. A communication system for performing route optimization for performing communication between a mobile node and a correspondent node by a direct route, without passing through a home agent of the mobile node, comprising:
a one-way route optimization means for performing communication on a one-way direct route in only a direction from the mobile node to the correspondent node,
the one-way route optimization means including
a home address test means by which the mobile node transmits a first request message to the correspondent node via the home agent, and the correspondent node responds to the first request message and transmits a first response message including message authentication code generation information to the mobile node via the home agent,
a care-of address test means by which the mobile node generates a first message authentication code from the message authentication code generation information within the first response message and transmits a second request message including the first message authentication code to the correspondent node via the one-way direct route, and the correspondent node authenticates the first message authentication code and transmits a second response message including a care-of address of the mobile node to the mobile node via the home agent, and
a binding update authentication means by which the mobile node generates a second message authentication code from the care-of address of the mobile node within the second response message and transmits a binding update message including the second message authentication code to the correspondent node via the one-way direct route, and the correspondent node authenticates the second message authentication code and transmits a binding confirmation message to the mobile node via the home agent.

3. A mobile node in a communication system for performing route optimization for performing communication between the mobile node and a correspondent node by a direct route, without passing through a home agent of the mobile node, the mobile node comprising:
a means for transmitting a first request message to the correspondent node via the home agent when communication is performed on a one-way direct route in only a direction from the mobile node to the correspondent node;
a means for receiving a first response message when the correspondent node responds to the first request message and transmits the first response message including message authentication code generation information via the home agent;
a means for generating a first message authentication code from the message authentication code generation information within the received first response message and transmitting a second request message including the first message authentication code to the correspondent node via the one-way direct route;
a means for receiving a second response message when the correspondent node authenticates the first message authentication code and transmits the second response message including a care-of address of the mobile node via the home agent;
a means for generating a second message authentication code from the care-of address of the mobile node within the received second response message and transmitting a binding update message including the second message authentication code via the one-way direct route; and
a means for receiving a binding confirmation message when the correspondent node authenticates the second message authentication code and transmits the binding confirmation message via the home agent.

4. A correspondent node in a communication system for performing route optimization for performing communication between a mobile node and the correspondent node by a direct route, without passing through a home agent of the mobile node, the correspondent node comprising:
a means for receiving a first request message when the mobile node transmits the first request message via the home agent when communication is performed on a one-way direct route in only a direction from the mobile node to the correspondent node;
a means for transmitting a first response message including message authentication code generation information to the mobile node via the home agent in response to the first request message;
a means for receiving a second request message when the mobile node generates a first message authentication code from the message authentication code generation information within the first response message and transmits the second request message including the first message authentication code via the one-way direct route;
a means for authenticating the first message authentication code within the second request message and transmitting a second response message including a care-of address of the mobile node to the mobile node via the home agent;
a means for receiving a binding update message when the mobile node generates a second message authentication code from the care-of address of the mobile node within the second response message and transmits the binding update message including the second message authentication code via the one-way direct route; and
a means for authenticating the second message authentication code within the binding update message and transmitting a binding confirmation message to the mobile node via the home agent.

5. The correspondent node according to claim 4, further comprising:
a means for setting a flag in a binding cache entry when communication is performed on a one-way direct route in only a direction from the mobile node to the correspondent node, the flag indicating that communication is performed on the one-way direct route in only the direction from the mobile node to the correspondent node; and
a means for transmitting a transmission packet addressed to the mobile node when the flag is set, a destination address of the packet being the home address, without the destination address being changed from the home address to the care-of address.

6. A communication method for performing route optimization for performing communication between a mobile node and a correspondent node by a direct route, without passing through a home agent of the mobile node, comprising a step of:
one-way route optimization at which communication is performed on a one-way direct route in only a direction from the correspondent node to the mobile node,
the one-way route optimization including
a home address test step at which the mobile node transmits a first request message to the correspondent node via the home agent, and the correspondent node responds to the first request message and transmits a first response message including message authentication code generation information to the mobile node via the home agent,
a care-of address test step at which the mobile node generates a first message authentication code from the message authentication code generation information within the first response message and transmits a second request message including the first message authentication code to the correspondent node via the home agent, and the correspondent node authenticates the first message authentication code and transmits a second response message including a home address of the mobile node to the mobile node via the one-way direct route, and
a binding update authentication step at which the mobile node generates a second message authentication code from the home address of the mobile node within the second response message and transmits a binding update message including the second message authentication code to the correspondent node via the home agent, and the correspondent node authenticates the second message authentication code and transmits a binding confirmation message to the mobile node via the one-way direct route.

7. A communication system for performing route optimization for performing communication between a mobile node and a correspondent node by a direct route, without passing through a home agent of the mobile node, comprising:
a one-way route optimization means for performing communication on a one-way direct route in only a direction from the correspondent node to the mobile node,
the one-way route optimization means including
a home address test means by which the mobile node transmits a first request message to the correspondent node via the home agent, and the correspondent node responds to the first request message and transmits a first response message including message authentication code generation information to the mobile node via the home agent,
a care-of address test means by which the mobile node generates a first message authentication code from the message authentication code generation information within the first response message and transmits a second request message including the first message authentication code to the correspondent node via the home agent, and the correspondent node authenticates the first message authentication code and transmits a second response message including a home address of the mobile node to the mobile node via the one-way direct route, and
a binding update authentication means by which the mobile node generates a second message authentication code from the home address of the mobile node within the second response message and transmits a binding update message including the second message authentication code to the correspondent node via the home agent, and the correspondent node authenticates the second message authentication code and transmits a binding confirmation message to the mobile node via the one-way direct route.

8. A mobile node in a communication system for performing route optimization for performing communication between the mobile node and a correspondent node by a direct route, without passing through a home agent of the mobile node, the mobile node comprising:
a means for transmitting a first request message to the correspondent node via the home agent when communication is performed on a one-way direct route in only a direction from the correspondent node to the mobile node;
a means for receiving a first response message when the correspondent node responds to the first request message and transmits the first response message including message authentication code generation information via the home agent;
a means for generating a first message authentication code from the message authentication code generation information within the received first response message and transmitting a second request message including the first message authentication code to the correspondent node via the home agent;
a means for receiving a second response message when the correspondent node authenticates the first message authentication code and transmits the second response message including a home address of the mobile node via the one-way direct route;
a means for generating a second message authentication code from the home address of the mobile node within the received second response message and transmitting a binding update message including the second message authentication code via the home agent; and
a means for receiving a binding confirmation message when the correspondent node authenticates the second message authentication code and transmits the binding confirmation message via the one-way direct route.

9. The mobile node according to claim 8, further comprising
a means for setting a flag in a binding cache entry when communication is performed on a one-way direct route in only a direction from the correspondent node to the mobile node, the flag indicating that communication is performed on the one-way direct route in only the direction from the correspondent node to the mobile node; and
a means for transmitting a transmission packet addressed to the correspondent node when the flag is set, a destination address of the packet being the home address, without the destination address being changed from the home address to the care-of address.

10. A correspondent node in a communication system for performing route optimization for performing communication between a mobile node and the correspondent node by a direct route, without passing through a home agent of the mobile node, the correspondent node comprising:
a means for receiving a first request message when the mobile node transmits the first request message via the home agent when communication is performed on a one-way direct route in only a direction from the correspondent node to the mobile node;
a means for transmitting a first response message including message authentication code generation information to the mobile node via the home agent in response to the received first request message;
a means for receiving a second request message when the mobile node generates a first message authentication code from the message authentication code generation information within the first response message and transmits the second request message including the first message authentication code via the home agent;
a means for authenticating the first message authentication code within the received second request message and transmitting a second response message including a home address of the mobile node to the mobile node via the one-way direct route;
a means for receiving a binding update message when the mobile node generates a second message authentication code from the home address of the mobile node within the second response message and transmits the binding update message including the second message authentication code via the home agent; and
a means for authenticating the second message authentication code within the binding update message and transmitting a binding confirmation message to the mobile node via the one-way direct route.

11. The mobile node according to claim 3, wherein, before transmitting the second request message, the mobile node transmits a request message that does not include the first message authentication code to the correspondent node via the one-way direct route, and transmits the second request message when a response message is not returned from the correspondent node via the one-way direct route.

12. The communication method according to claim 1, wherein, when communication is performed on a one-way direct route in only a direction from the mobile node to the correspondent node refers to when the mobile node has a plurality of interfaces, a plurality of correspondent nodes are present, and the mobile node transmits a transmission packet to each of the plurality of correspondent nodes from each of the plurality of interfaces.

13. The communication method according to claim 6, wherein when communication is performed on a one-way direct route in only a direction from the correspondent node to the mobile node refers to when the mobile node has a plurality of interfaces, a plurality of correspondent nodes are present, and the mobile node transmits a transmission packet from each of the plurality of correspondent nodes to each of the plurality of interfaces.

14. The mobile node according to claim 8, wherein, before transmitting the second request message, the mobile node transmits a request message that does not include the first message authentication code to the correspondent node via the one-way direct route, and transmits the second request message when a response message is not returned from the correspondent node via the one-way direct route.
